(19) United States
(12) Patent Application Publication
(10) Pub. No.: US 2023/0389087 A1
(43) Pub. Date: Nov. 30, 2023

(54) WAVEFORM SWITCHING FOR WIRELESS COMMUNICATIONS

(71) Applicant: QUALCOMM Incorporated, San Diego, CA (US)

(72) Inventors: Mahmoud Taherzadeh Boroujeni, San Diego, CA (US); Tao Luo, San Diego, CA (US); Peter Gaal, San Diego, CA (US); Iyab Issam Sakhnini, San Diego, CA (US)

(21) Appl. No.: 17/824,834

(22) Filed: May 25, 2022

(51) Int. Cl. H04W 74/08; H04W 72/12; H04W 72/04

(52) U.S. Cl. CPC H04W 74/0841; H04W 74/0866; H04W 72/1268; H04W 72/0453; H04W 72/048

(57) ABSTRACT

Methods, systems, and devices for wireless communications and waveform type switching are described. If a user equipment (UE) receives an indication to switch waveform type after transmitting a first portion of a set of uplink messages, the UE may use a different waveform type to transmit a remaining portion of the set of uplink messages. If one or more conditions are satisfied at the UE, then the UE may transmit, to a network entity, a request to change the waveform type used for uplink transmissions by the UE. The UE may determine a waveform type to use for an uplink transmission as part of a random access procedure based on information included in a downlink transmission that is received as part of the random access procedure.

### FIELD OF TECHNOLOGY

The following relates to wireless communications, including waveform switching for wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). In some wireless communications systems, communication devices may support multiple waveform types for performing wireless communications.

### SUMMARY

The described techniques relate to improved methods, systems, devices, and apparatuses that support waveform switching for wireless communications. For example, the described techniques provide frameworks for dynamic waveform switching at a user equipment (UE) for uplink transmissions. In some examples, a UE may receive first signaling that schedules uplink messages for the UE. The UE may transmit a first portion of the uplink messages in accordance with a first waveform type associated with a first set of parameters. The UE may receive second signaling that indicates for the UE to transition from the first waveform type associated with the first set of parameters to a second waveform type associated with a second set of parameters. The UE may transmit a second portion of the set of uplink message in accordance with the second waveform type associated with the second set of parameters.

In some examples, the UE may transmit one or more uplink messages in accordance with the first waveform type associated with the first set of parameters. The first set of parameters may correspond to a first type of modulation, or a first type of pulse shape, or both. Additionally or alternatively the first set of parameters may include a first set of filtering parameters. The UE may determine that a condition associated with uplink transmissions at the UE satisfies a threshold based on transmitting the one or more uplink messages. The UE may transmit a request to transition from the first waveform type associated with the first set of parameters to a second waveform type associated with a second set of parameters. The second set of parameters may correspond to a second type of modulation, or a second type of pulse shape, or both. Additionally, or alternatively, the second type of parameters may include a second set of filtering parameters.

In some examples, the UE may receive first signaling indicative of a rule pertaining to waveform type selection for a type of uplink message included in a random access procedure. The rule may be associated with information within a type of downlink message included in the random access procedure. The UE may receive, during the random access procedure, the information within a downlink message of the type of downlink message. The UE may determine a waveform type for an uplink message of the type of uplink message based on the information included in the downlink message and the rule. The UE may transmit, during the random access procedure, the uplink message using the determined waveform type.

A method for wireless communication at a user equipment (UE) is described. The method may include receiving first signaling that schedules a set of uplink messages for the UE, transmitting a first portion of the set of uplink messages in accordance with a first waveform type associated with a first set of parameters, receiving second signaling that indicates for the UE to transition from the first waveform type associated with the first set of parameters to a second waveform type associated with a second set of parameters, and transmitting a second portion of the set of uplink messages in accordance with the second waveform type associated with the second set of parameters.

An apparatus for wireless communication is described. The apparatus may include a memory, a transceiver, and at least one processor of a UE, the at least one processor coupled with the memory and the transceiver. The at least one processor may be configured to receive first signaling that schedules a set of uplink messages for the UE, transmit a first portion of the set of uplink messages in accordance with a first waveform type associated with a first set of parameters, receive second signaling that indicates for the UE to transition from the first waveform type associated with the first set of parameters to a second waveform type associated with a second set of parameters, and transmit a second portion of the set of uplink messages in accordance with the second waveform type associated with the second set of parameters.

Another apparatus for wireless communication at a UE is described. The apparatus may include means for receiving first signaling that schedules a set of uplink messages for the UE, means for transmitting a first portion of the set of uplink messages in accordance with a first waveform type associated with a first set of parameters, means for receiving second signaling that indicates for the UE to transition from the first waveform type associated with the first set of parameters to a second waveform type associated with a second set of parameters, and means for transmitting a second portion of the set of uplink messages in accordance with the second waveform type associated with the second set of parameters.

A non-transitory computer-readable medium storing code for wireless communication at a UE is described. The code may include instructions executable by a processor to receive first signaling that schedules a set of uplink messages for the UE, transmit a first portion of the set of uplink messages in accordance with a first waveform type associated with a first set of parameters, receive second signaling that indicates for the UE to transition from the first waveform type associated with the first set of parameters to a second waveform type associated with a second set of parameters, and transmit a second portion of the set of uplink messages in accordance with the second waveform type associated with the second set of parameters.

In some examples of the method, apparatuses, and non-transitory computer-readable medium described herein, the second signaling may be received after transmitting at least one uplink message included in the first portion of the set of uplink messages and the method, apparatuses, and non-transitory computer-readable medium may include further operations, features, means, or instructions for transitioning from the first waveform type to the second waveform type based on an elapsed time since the second signaling may be received at the UE satisfying a threshold, where transmitting the second portion of the set of uplink messages in accordance with the second waveform type may be based on the transitioning.

Some examples of the method, apparatuses, and non-transitory computer-readable medium described herein may further include operations, features, means, or instructions for determining that the first portion of the set of uplink messages may be associated with a set of reference signals for performing channel estimation and waiting to transition from the first waveform type to the second waveform type until after transmitting the first portion of the set of uplink messages, the waiting based on the determination that the first portion of the set of uplink messages may be associated with the set of reference signals for performing channel estimation.

Some examples of the method, apparatuses, and non-transitory computer-readable medium described herein may further include operations, features, means, or instructions for receiving third signaling indicating that the UE may be allowed to transmit different portions of the set of uplink messages in accordance with different waveform types, where transmitting the second portion of the set of uplink messages in accordance with the second waveform type may be based on the third signaling indicating that the UE may be allowed to transmit different portions of the set of uplink messages in accordance with different waveform types.

Some examples of the method, apparatuses, and non-transitory computer-readable medium described herein may further include operations, features, means, or instructions for transmitting an indication of a UE capability associated with waveform type switching at the UE, where receiving the second signaling indicating for the UE to transition from the first waveform type to the second waveform type may be based on the UE capability.

In some examples of the method, apparatuses, and non-transitory computer-readable medium described herein, the UE capability may be based on one or more frequencies configured for the wireless communication.

A method for wireless communication at a UE is described. The method may include transmitting one or more uplink messages in accordance with a first waveform type associated with a first set of parameters, where the first set of parameters correspond to a first type of modulation, correspond to a first type of pulse shape, include a first set of filtering parameters, or any combination thereof, determining, based on transmitting the one or more uplink messages, that a condition associated with uplink transmissions at the UE satisfies a threshold, and transmitting, based on the determination, a request to transition from the first waveform type associated with the first set of parameters to a second waveform type associated with a second set of parameters, where the second set of parameters correspond to a second type of modulation, correspond to a second type of pulse shape, include a second set of filtering parameters, or any combination thereof.

An apparatus for wireless communication is described. The apparatus may include a memory, a transceiver, and at least one processor of a UE, the at least one processor coupled with the memory and the transceiver. The at least one processor may be configured to transmit one or more uplink messages in accordance with a first waveform type associated with a first set of parameters, where the first set of parameters correspond to a first type of modulation, correspond to a first type of pulse shape, include a first set of filtering parameters, or any combination thereof, determine, based on transmitting the one or more uplink messages, that a condition associated with uplink transmissions at the UE satisfies a threshold, and transmit, based on the determination, a request to transition from the first waveform type associated with the first set of parameters to a second waveform type associated with a second set of parameters, where the second set of parameters correspond to a second type of modulation, correspond to a second type of pulse shape, include a second set of filtering parameters, or any combination thereof.

Another apparatus for wireless communication at a UE is described. The apparatus may include means for transmitting one or more uplink messages in accordance with a first waveform type associated with a first set of parameters, where the first set of parameters correspond to a first type of modulation, correspond to a first type of pulse shape, include a first set of filtering parameters, or any combination thereof, means for determining, based on transmitting the one or more uplink messages, that a condition associated with uplink transmissions at the UE satisfies a threshold, and means for transmitting, based on the determination, a request to transition from the first waveform type associated with the first set of parameters to a second waveform type associated with a second set of parameters, where the second set of parameters correspond to a second type of modulation, correspond to a second type of pulse shape, include a second set of filtering parameters, or any combination thereof.

A non-transitory computer-readable medium storing code for wireless communication at a UE is described. The code may include instructions executable by a processor to transmit one or more uplink messages in accordance with a first waveform type associated with a first set of parameters, where the first set of parameters correspond to a first type of modulation, correspond to a first type of pulse shape, include a first set of filtering parameters, or any combination thereof, determine, based on transmitting the one or more uplink messages, that a condition associated with uplink transmissions at the UE satisfies a threshold, and transmit, based on the determination, a request to transition from the first waveform type associated with the first set of parameters to a second waveform type associated with a second set of parameters, where the second set of parameters correspond to a second type of modulation, correspond to a second type of pulse shape, include a second set of filtering parameters, or any combination thereof.

In some examples of the method, apparatuses, and non-transitory computer-readable medium described herein, determining that the condition associated with uplink transmissions at the UE satisfies the threshold may include operations, features, means, or instructions for determining that a power headroom for the UE may have crossed the threshold, where transmitting the request to transition from the first waveform type to the second waveform type may be based on determining that the power headroom for the UE may have crossed the threshold.

Some examples of the method, apparatuses, and non-transitory computer-readable medium described herein may further include operations, features, means, or instructions for receiving, in response to transmitting the request, a grant to transition from the first waveform type to the second waveform type and transitioning from the first waveform type to the second waveform type based on receiving the grant.

Some examples of the method, apparatuses, and non-transitory computer-readable medium described herein may further include operations, features, means, or instructions for identifying a configuration for waveform type selection at the UE and transitioning from the first waveform type to the second waveform type in accordance with the configuration and based on transmitting the request.

In some examples of the method, apparatuses, and non-transitory computer-readable medium described herein, the configuration indicates whether the UE may be allowed to transition between waveform types for one or more types of uplink messages and transitioning from the first waveform type to the second waveform type may be based on the one or more uplink messages including a type of uplink messages included in the one or more types of uplink messages.

In some examples of the method, apparatuses, and non-transitory computer-readable medium described herein, the configuration includes a threshold for transitioning between waveform types and the condition includes the threshold being satisfied by one or more metrics associated with uplink transmissions by the UE.

In some examples of the method, apparatuses, and non-transitory computer-readable medium described herein, the configuration includes a time duration associated with transitioning between waveform types, the time duration may be measured from a time at which the UE transmits the request, and transitioning from the first waveform type to the second waveform type occurs after at least the time duration may have elapsed since transmitting the request.

In some examples of the method, apparatuses, and non-transitory computer-readable medium described herein, the condition includes a non-linearity metric associated with a power amplifier at the UE, a power headroom, a peak to average power ratio, an average transmit power, or any combination thereof.

A method for wireless communication at a UE is described. The method may include receiving first signaling indicative of a rule pertaining to waveform type selection for a type of uplink message included in a random access procedure, the rule associated with information within a type of downlink message included in the random access procedure, receiving, during the random access procedure, the information within a downlink message of the type of downlink message, determining a waveform type for an uplink message of the type of uplink message based on the information included in the downlink message and the rule, and transmitting, during the random access procedure, the uplink message using the determined waveform type.

An apparatus for wireless communication is described. The apparatus may include a memory, a transceiver, and at least one processor of a UE, the at least one processor coupled with the memory and the transceiver. The at least one processor may be configured to receive first signaling indicative of a rule pertaining to waveform type selection for a type of uplink message included in a random access procedure, the rule associated with information within a type of downlink message included in the random access procedure, receive, during the random access procedure, the information within a downlink message of the type of downlink message, determine a waveform type for an uplink message of the type of uplink message based on the information included in the downlink message and the rule, and transmit, during the random access procedure, the uplink message using the determined waveform type.

Another apparatus for wireless communication at a UE is described. The apparatus may include means for receiving first signaling indicative of a rule pertaining to waveform type selection for a type of uplink message included in a random access procedure, the rule associated with information within a type of downlink message included in the random access procedure, means for receiving, during the random access procedure, the information within a downlink message of the type of downlink message, means for determining a waveform type for an uplink message of the type of uplink message based on the information included in the downlink message and the rule, and means for transmitting, during the random access procedure, the uplink message using the determined waveform type.

A non-transitory computer-readable medium storing code for wireless communication at a UE is described. The code may include instructions executable by a processor to receive first signaling indicative of a rule pertaining to waveform type selection for a type of uplink message included in a random access procedure, the rule associated with information within a type of downlink message included in the random access procedure, receive, during the random access procedure, the information within a downlink message of the type of downlink message, determine a waveform type for an uplink message of the type of uplink message based on the information included in the downlink message and the rule, and transmit, during the random access procedure, the uplink message using the determined waveform type.

In some examples of the method, apparatuses, and non-transitory computer-readable medium described herein, determining the waveform type based on the information included in the downlink message and the rule may include operations, features, means, or instructions for interpreting a bitfield of the downlink message in accordance with the rule, the bitfield including the information and determining the waveform type based on the interpretation of the bitfield.

Some examples of the method, apparatuses, and non-transitory computer-readable medium described herein may further include operations, features, means, or instructions for performing the random access procedure as part of a beam failure recovery procedure or a handover procedure, where determining the waveform type may be based on the random access procedure being performed as part of the beam failure recovery procedure or the handover procedure.

Some examples of the method, apparatuses, and non-transitory computer-readable medium described herein may further include operations, features, means, or instructions for transmitting an indication of a request to transition from a first waveform type to a second waveform type for the type of uplink message, where receiving the first signaling may be based on transmitting the request.

In some examples of the method, apparatuses, and non-transitory computer-readable medium described herein, transmitting the request to transition from the first waveform type to the second waveform type may include operations, features, means, or instructions for transmitting a random access preamble via a random access occasion, where the request may be indicated by the random access occasion, a sequence associated with the random access preamble, or both, transmitting a random access preamble over one or more frequency resources, where the request may be indicated by the one or more frequency resources, a bandwidth part associated with the one or more frequency resources, or both, and transmitting a set of two or more random access preambles, where the request may be indicated by the set of two or more random access preambles.

Some examples of the method, apparatuses, and non-transitory computer-readable medium described herein may further include operations, features, means, or instructions for transmitting an indication of a UE capability associated with waveform type selection at the UE, where receiving the first signaling may be based on the UE capability.

### BRIEF DESCRIPTION OF THE DRAWINGS

FIGS. 1 and 2 each illustrate an example of a wireless communications system that supports waveform switching for wireless communications in accordance with one or more aspects of the present disclosure.

FIGS. 3 through 5 each illustrate an example of a process flow that supports waveform switching for wireless communications in accordance with one or more aspects of the present disclosure.

FIGS. 6 and 7 show block diagrams of devices that support waveform switching for wireless communications in accordance with one or more aspects of the present disclosure.

FIG. 8 shows a block diagram of a communications manager that supports waveform switching for wireless communications in accordance with one or more aspects of the present disclosure.

FIG. 9 shows a diagram of a system including a device that supports waveform switching for wireless communications in accordance with one or more aspects of the present disclosure.

FIGS. 10 through 12 show flowcharts illustrating methods that support waveform switching for wireless communications in accordance with one or more aspects of the present disclosure.

### DETAILED DESCRIPTION

A wireless communications system may include communication devices, such as a user equipment (UE) or one or more network entities. A network entity may be an example of a wired or wireless network node that may support one or multiple radio access technologies. Examples of radio access technologies may include fourth generation (4G) systems, such as LTE systems, and fifth generation (5G) systems, which may be referred to as 5G new radio (NR) systems, among other wireless communications systems (e.g., subsequent generations of wireless communications systems) or one or more other network entities. In some examples, communication devices (e.g., UEs, network entities) operating within a wireless communication system may communicate using multiple (e.g., different) types of waveforms.

For example, a UE may support multiple waveform types (e.g., a cyclic prefix orthogonal frequency division multiplexing (CP-OFDM) waveform or a direct Fourier transform spread orthogonal frequency division multiplexing (DFT-s-OFDM) waveform) for transmitting uplink communications. In some examples, the CP-FDM waveform may be suitable if a received power at the UE is relatively high (e.g., signal fading is relatively low, the channel conditions are relatively favorable). Additionally, or alternatively, the DFT-s-OFDM waveform may be suitable if the received power at the UE is relatively low (e.g., signal fading is relatively high, the channel conditions are relatively poor). As such, it may be desirable for the UE (or the network entity) to determine whether to use the CP-OFDM waveform or the DFT-s-OFDM waveform based on channel conditions experienced at the UE (or the network entity).

In some examples, the network entity may transmit an indication for the UE to use a particular waveform type using dynamic signaling, such as a downlink control information (DCI)). In some examples, however, the UE may receive the indication after transmitting a portion of a set of uplink transmissions configured for the UE (e.g., a bundle of reference signals to be transmitted from the UE for channel estimation at the network, uplink repetitions) and the UE may not be capable of determining which waveform type to use for transmitting remaining uplink messages (e.g., of the configured set). In such an example, the UE may be configured to switch waveform types (e.g., transition from the first waveform type used to transmit uplink messages prior to receiving the indication to a second waveform type) during a time duration for transmitting the configured set of uplink messages (e.g., for transmitting the uplink repetitions). For example, if the UE is scheduled to transmit a set of uplink messages during the time duration and receives the indication (e.g., the DCI) to use another (e.g., a different) waveform type during the time duration, the UE may transmit a portion of the set of uplink messages using the first waveform type (e.g., a current or previous waveform type) and another portion of the set of uplink messages using the second waveform type (e.g., the waveform type indicated using the DCI). Additionally, or alternatively, the network may configure the UE to refrain from switching, for example if the set of uplink messages include reference signals to be used for channel estimation (e.g., at the network entity).

In some examples, the network may indicate for the UE to use a particular waveform irrespective of channel conditions experienced at the UE and, as such, the waveform type indicated using the DCI may not be suitable for the UE. In such examples, the UE may transmit a request (e.g., to the network entity) to switch waveform types (e.g., to transition from the waveform type configured for the UE to another waveform type). For example, if the UE determines that a condition associated with transmitting uplink messages (e.g., a power headroom, an average transmit power, a peak to average power ratio (PAPR), non-linearities of a power amplifier at the UE) satisfies a threshold (e.g., exceeds or fails to exceed depending on the condition), the UE may transmit a request to switch waveform types. In some examples, the UE may transmit the request using uplink control information (UCI) or a medium access control control message (MAC-CE). Additionally, or alternatively, the threshold may be configured at the UE, for example from the network.

Moreover, in some examples, because the network entity may indicate a waveform type to the UE using a DCI, the UE may not be capable of determining (e.g., and the network may not be capable of indicating) a waveform type to be used at the UE for (e.g., during or subsequent to) random access procedures performed at the UE. A random access procedure may, in some examples, be referred to as a random access channel (RACH) procedure. In such examples, the UE may be configured with a rule for selecting a waveform type during a random access procedure. For example, the network entity may transmit control signaling to the UE that indicates a rule for interpreting information included in a message transmitted from the network entity as part of (e.g., during) a random access procedure (e.g., a message transmitted from the network entity as part of a contention free random access (CFRA) procedure). In such an example, the UE may determine a waveform type based on the information included in the message and the configured rule. In some examples, the UE may request to switch waveforms during the random access procedure using a random access preamble. For examples, the UE may indicate a request to switch waveforms using a preamble that may be transmitted using a particular a random access occasion, using one or more particular frequency resources, or through transmission of two consecutive random access preambles.

Particular aspects of the subject matter described herein may be implemented to realize one or more of the following potential advantages. The techniques employed at the described communication devices may provide benefits and enhancements to the operation of the communication devices, including enabling frameworks for switching waveform types for uplink transmissions at a UE. For example, operations performed at the described communication devices may provide improvements to system capacity and resource utilization within a wireless communications system. In some implementations, the operations performed at the described communication devices to improve system capacity and resource utilization within the wireless communications system include configuring a UE to switch waveform types during a time duration for transmitting a set of uplink messages (e.g., for transmitting uplink repetitions), configuring a UE to transmit a request to switch waveform types, and configuring a UE with a rule for selecting a waveform type during a random access procedure. In some other implementations, operations performed at the described communication devices may also support reduced power consumption, increased throughput, and higher data rates, among other benefits.

Aspects of the disclosure are initially described in the context of wireless communications systems. Aspects of the disclosure are further illustrated through and described with reference to process flows, apparatus diagrams, system diagrams, and flowcharts that relate to waveform switching for wireless communications.

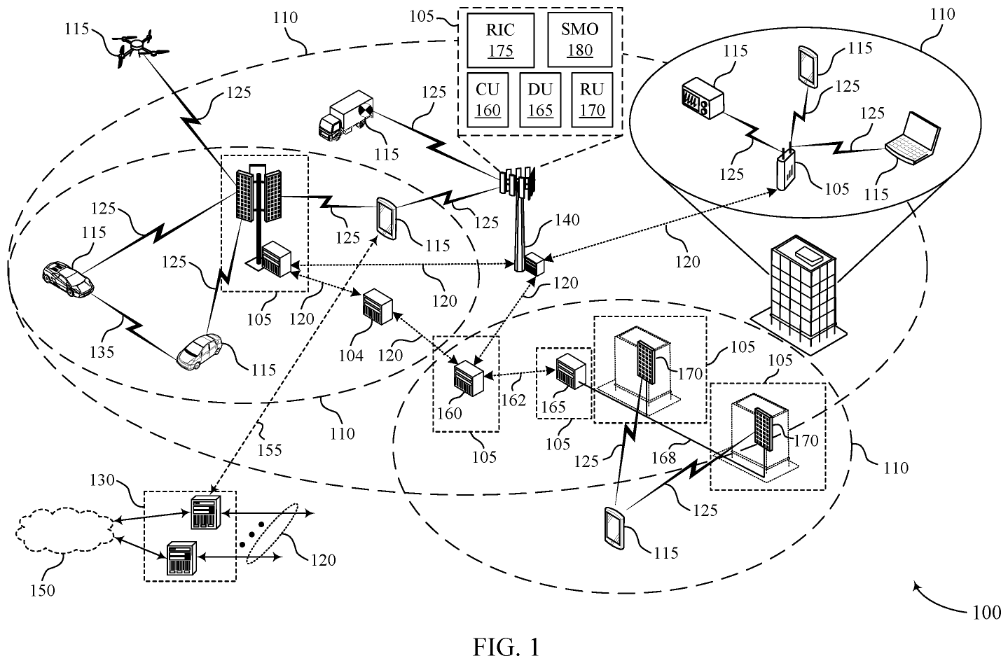

FIG. 1 illustrates an example of a wireless communications system 100 that supports waveform switching for wireless communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support waveform switching for wireless communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may support one or more frameworks for dynamic waveform switching at a UE 115 (e.g., for uplink transmissions). For example, a UE 115 may receive first signaling that schedules uplink messages for the UE 115. The UE 115 may transmit a first portion of the uplink messages in accordance with a first waveform type associated with a first set of parameters. The UE 115 may receive second signaling that indicates for the UE 115 to transition from the first waveform type associated with the first set of parameters to a second waveform type associated with a second set of parameters. The UE 115 may transmit a second portion of the set of uplink message in accordance with the second waveform type associated with the second set of parameters.

In some examples, the UE 115 may transmit one or more uplink messages in accordance with the first waveform type associated with the first set of parameters. The first set of parameters may correspond to a first type of modulation, or a first type of pulse shape, or both. Additionally or alternatively the first set of parameters may include a first set of filtering parameters. The UE 115 may determine that a condition associated with uplink transmissions at the UE satisfies a threshold based on transmitting the one or more uplink messages. The UE 115 may transmit a request to transition from the first waveform type associated with the first set of parameters to a second waveform type associated with a second set of parameters. The second set of parameters may correspond to a second type of modulation, or a second type of pulse shape, or both. Additionally, or alternatively, the second type of parameters may include a second set of filtering parameters.

In some examples, the UE 115 may receive first signaling indicative of a rule pertaining to waveform type selection for a type of uplink message included in a random access procedure. The rule may be associated with information within a type of downlink message included in the random access procedure. The UE 115 may receive, during the random access procedure, the information within a downlink message of the type of downlink message. The UE 115 may determine a waveform type for an uplink message of the type of uplink message based on the information included in the downlink message and the rule. The UE 115 may transmit, during the random access procedure, the uplink message using the determined waveform type. In some examples, transitioning (e.g., switch dynamically) between waveform types may lead to an increased reliability of communications between the UE 115 and the network (e.g., one or more network entities 105), among other possible benefits.

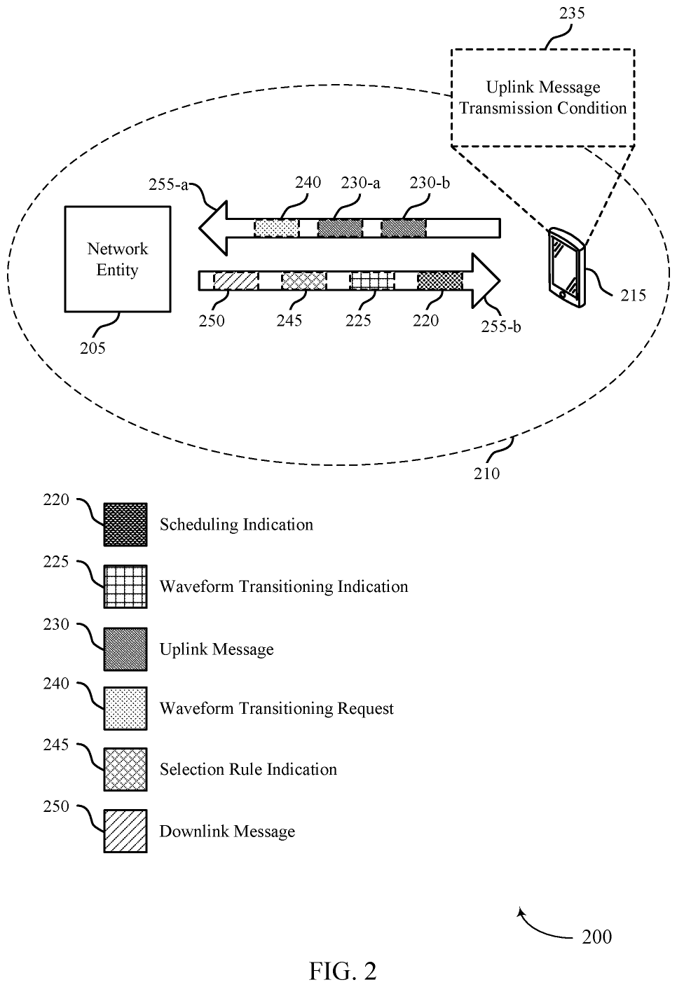

FIG. 2 illustrates an example of a wireless communications system 200 that supports waveform switching for wireless communications in accordance with one or more aspects of the present disclosure. In some examples, the wireless communications system 200 may implement or be implemented at or using one or more aspects of the wireless communications system 100. For example, the wireless communications system 200 may include a UE 215 and a network entity 205, which may be examples of the corresponding devices as described with reference to FIG. 1. In the example of FIG. 2, the network entity 205 may be an example of a CU, a DU, an RU, a base station, an IAB node, a transmission and reception point, or one or more other network nodes as described with reference to FIG. 1.

The network entity 205 and the UE 215 may communicate within the coverage area 210, which may be examples of a coverage area 110 as described with reference to FIG. 1. For example, the UE 215 and the network entities 205 may communicate using one or more communication links 255 (e.g., a communication link 255-a and a communication link 255-b). In some examples, the UE 215 may transmit communications (e.g., uplink communications) to the network entity 205 using the communication link 255-a and the network entity 205 may transmit communications (e.g., downlink communications) to the UE 215 using the communication link 255-b. In the example of FIG. 2, the communication link 255-a may be an uplink and the communication link 255-b may be a downlink. Additionally, or alternatively, the communication links 255 may each be an example of a communication link 125 as described with reference to FIG. 1. The wireless communications system 200 may include features for improved communications between the UE 215 and the network entity 205, among other benefits.

In some examples of the wireless communications system 200, a communication device (e.g., the UE 215, the network entity 205) may be capable of transmitting communications using multiple (e.g., different) types of waveforms. For example, the UE 215 may support multiple waveform types (e.g., a CP-OFDM waveform or a DFT-s-OFDM waveform) for transmitting uplink communications to the network entity 205. In some examples, the network may configure the UE 215 to use a waveform type irrespective of the radio conditions (e.g., channel conditions) experienced at the UE 215. For example, the network may configure the UE 215 to use a waveform type based on the cell in which the UE 215 may be operating (e.g., the configured waveform type may be cell-specific), among other examples. In some examples, usage of the DFT-s-OFDM waveform or the CP-OFDM waveform may be determined (e.g., at the UE) through enabling or disabling transform precoding (e.g., using a configuration). For example, a waveform type (e.g., a waveform type to be used for uplink transmissions, an uplink waveform type) may be configured using a random access configuration (e.g., a RACH common configuration, such as using a RACH-ConfigCommon.msg3-transformPrecoding information element (IE)) for random access, or using an uplink shared channel configuration (e.g., using a PUSCH-Config.transformPrecoding IE) for a physical uplink shared channel (PUSCH) in an RRC-connected mode. In such examples, the UE 215 may consider the transform precoding either enabled (e.g., indicating for the UE 215 to use the DFT-s-OFDM waveform) or disabled (e.g., indicating for the UE 215 to use the CP-OFDM waveform) based on configuration (e.g., the RACH-ConfigCommon.msg3-transformPrecoding IE, the PUSCH-Config.transformPrecoding IE). It is to be understood that the names of IEs described herein may change based on implementation of one or multiple devices (e.g., the UE 215, the network entity 205, or both), and the examples described herein should not be considered limiting to the scope covered in the claims or the disclosure.

In some examples, the network entity 205 may transmit an indication for the UE 215 to use a particular waveform type using dynamic signaling, such as using DCI. For example, the network entity 205 may transmit a waveform indication (e.g., a waveform type indication) using a scheduling DCI (e.g., a DCI transmitted to the UE 215 to schedule communications for the UE). That is, the network entity 205 and the UE 215 may support dynamic waveform switching, such as to provide one or more enhancements to wireless communications within the wireless communications system 200. In some examples, the dynamic waveform switching may occur between the DFT-S-OFDM waveform and CP-OFDM waveform. For example, using the CP-OFDM waveform may lead to increased spectral packing efficiency. Additionally, or alternatively, the CP-OFDM waveform may enable the network to improve management of resource block allocation. In some examples, using the DFT-s-OFDM waveform may lead to a reduced PAPR and, as such, transmission of signals at an increased power (e.g., relative to signals transmitted using the CP-OFDM waveform), thereby leading to increased signal coverage. Accordingly, the CP-OFDM waveform may be suitable for scenarios in which the received power at the UE 215 may be relatively high (e.g., signal fading may be relatively low, channel conditions relatively favorable, channel conditions satisfy a threshold) and the DFT-s-OFDM waveform may be suitable for scenarios in which the received power at the UE 215 may be relatively low (e.g., signal fading may be relatively high, the channel conditions may be reduced). That is, the DFT-s-OFDM waveform may provide one or more benefits for uplink coverage due to a reduced PAPR relative to the CP-OFDM waveform.

In some examples, however, the network entity 205 may transmit an indication (e.g., the DCI including the waveform type indication) between repetitions of the PUSCH (e.g., PUSCH repetitions scheduled for the UE 215). In some examples, repetitions may refer to multiple transmissions that include similar (e.g., the same) information. Additionally, or alternatively, repetitions may refer to multiple transmission that are scheduled using a same message (e.g., a same DCI message). In some examples, the UE 215 may receive the indication (e.g., the DCI including the waveform type indication) after transmitting a portion of a set of uplink transmissions (e.g., a bundle of reference signals) configured for the UE 215. In such examples, the UE 215 may not be capable of determining which waveform type to use for transmitting remaining uplink messages (e.g., of the configured set). In some examples, however, the UE 215 may be configured to switch waveform types (e.g., transition from the first waveform type used to transmit uplink messages prior to receiving the indication to a second waveform type) during a time duration for transmitting the configured set of uplink messages (e.g., for transmitting the uplink repetitions). For example, the UE 215 may receive first signaling (e.g., a scheduling indication 220) that schedules a set of uplink messages for the UE 215. The UE 215 may transmit a first portion of the set of uplink messages (e.g., an uplink message 230-a) in accordance with a first waveform type associated with a first set of parameters. For example, the UE may transmit the uplink message 230-a using one of the CP-OFDM waveform or the DFT-s-OFDM waveform. Additionally, or alternatively, the UE 215 may receive second signaling (e.g., a waveform transitioning indication 225) that indicates for the UE 215 to transition from the first waveform type associated with the first set of parameters to a second waveform type associated with a second set of parameters. For example, the waveform transitioning indication 225 may indicate for the UE 215 to use a different one of the CP-OFDM waveform or the DFT-s-OFDM waveform or the waveform transitioning indication 225 may indicate for the UE 215 to use a same waveform type that may be associated with a different set of parameters. The UE 215 may transmit a second portion of the set of uplink messages (e.g., an uplink message 230-b) in accordance with the second waveform type associated with the second set of parameters.

In some examples, the network entity 205 may indicate for the UE 215 to use a particular waveform irrespective of channel conditions experienced at the UE 215 and, as such, the waveform type indicated using the DCI may not be suitable for the UE 215. That is, the UE 215 may determine that an indicated waveform type (or a current waveform type) may not be suitable (e.g., may not provide a suitable PAPR, may not provide a suitable transmit power, or may result in power amplifier nonlinearities). In such examples, the UE 215 may transmit a request (e.g., to the network entity 205) to switch waveform types (e.g., to transition from a waveform type configured for the UE 215 to another waveform type). For example, the UE 215 may transmit one or more uplink messages 230 in accordance with a first waveform type associated with a first set of parameters (e.g., the CP-OFDM waveform or the DFT-s-OFDM waveform). In some examples, the first set of parameters may correspond to a first type of modulation or a first type of pulse shape (or both). Additionally, or alternatively, the first set of parameters may include a first set of filtering parameters. The UE 215 may determine, based on transmitting the one or more uplink messages 230, that a condition (e.g., an uplink message transmission condition 235) associated with uplink transmissions at the UE 215 satisfies a threshold. In some examples, based on determining that the uplink message transmission condition 235 satisfies the threshold, the UE 215 may transmit a request (e.g., a waveform transitioning request 240) to transition from the first waveform type (e.g., one of the CP-OFDM waveform or the DFT-s-OFDM waveform) associated with the first set of parameters to a second waveform type associated with a second set of parameters (e.g., a different one of the CP-OFDM waveform or the DFT-s-OFDM waveform or a same one of the CP-OFDM waveform or the DFT-s-OFDM waveform with a different set of parameters). The second set of parameters may correspond to a second type of modulation or a second type of pulse shape (or both). Additionally, or alternatively, the second set of parameters may include a second set of filtering parameters.

In some examples, during a random access procedure, the UE 215 may receive an indication (e.g., from the network entity 205) of multiple uplink messages (e.g., repetitions of a third message transmitted during a random access procedure, Msg3 repetitions) to be transmitted from the UE 215 during a random access procedure. In some examples, the UE 215 may receive (e.g., determine) the indication (e.g., of the multiple messages to be transmitted from the UE 215 during the random access procedure) using an interpretation of a modulation coding scheme bitfield of a downlink message transmitted during the random access procedure (e.g., a second message transmitted during the random access procedure, a Msg2 indicating an initial Msg3) or using a DCI that schedules multiple uplink messages (e.g., repetitions of a third message transmitted during a random access procedure, Msg3 repetitions) to be transmitted from the UE 215 during a random access procedure. That is, a third message (e.g., Msg3 repetition) transmitted from the UE 215 as part of a random access procedure, and an interpretation of the MCS bitfield of a second message (e.g., Msg2) transmitted from the network entity 205, may be conditioned on a UE request, for example transmitted from the UE 215 using a physical random access channel (PRACH) preamble (e.g., using a subset of PRACH preambles). In some examples, the UE request (e.g., to send repetitions of the third message) may implicitly indicate one or more capabilities (e.g., uplink transmission capabilities) of the UE 215.

In some examples, the UE 215 may perform the random access procedure (or multiple random access procedures) as part of a beam failure recover procedure or a handover procedure. For example, the UE 215 may perform the random access procedure in response to experiencing a connection failure (e.g., a radio link failure) between the UE 215 and the network entity 205. In such an example, a received power at the UE 215 may be relatively low (e.g., signal fading may be relatively high, the channel conditions may be reduced). As such, waveform switching (e.g., switching to the DFT-S-OFDM waveform) may provide for coverage enhancement of uplink messages transmitted as part of the random access procedure (e.g., repetitions of a third message transmitted during the random access procedure, contention free random access PUSCH transmissions). However, because the network entity 205 may use a DCI to indicate a waveform type to the UE 215, the UE 215 may not be capable of determining (e.g., and the network entity 205 may not be capable of indicating) a waveform type to be used at the UE 215 for uplink transmissions (e.g., during or subsequent to) random access procedures performed at the UE 215.

In some examples, the UE 215 may be configured (e.g., from the network entity 205) with a rule for selecting a waveform type during a random access procedure. For example, the network entity 205 may transmit control signaling (e.g., including a selection rule indication 245) to the UE 215 that indicates a rule for interpreting information included in a message transmitted from the network entity 205 (e.g., a downlink message 250) as part of (e.g., during) a random access procedure (e.g., a second message transmitted from the network entity 205 as part of a contention free random access procedure, Msg2). In such an example, the UE 215 may determine a waveform type based on the information included in the message and the configured rule. In some examples, the UE 215 may request to switch waveforms during the random access procedure using a random access preamble (e.g., a PRACH preamble). For examples, the UE 215 may indicate a request to switch waveforms though transmission of a preamble using a particular a random access occasion, using one or more particular frequency resources, or through transmission of multiple (e.g., two) consecutive random access preambles. In some examples, transitioning (e.g., switching dynamically) between waveform types my increase the reliability of communications between the UE 215 and the network entity 205, among other possible benefits.

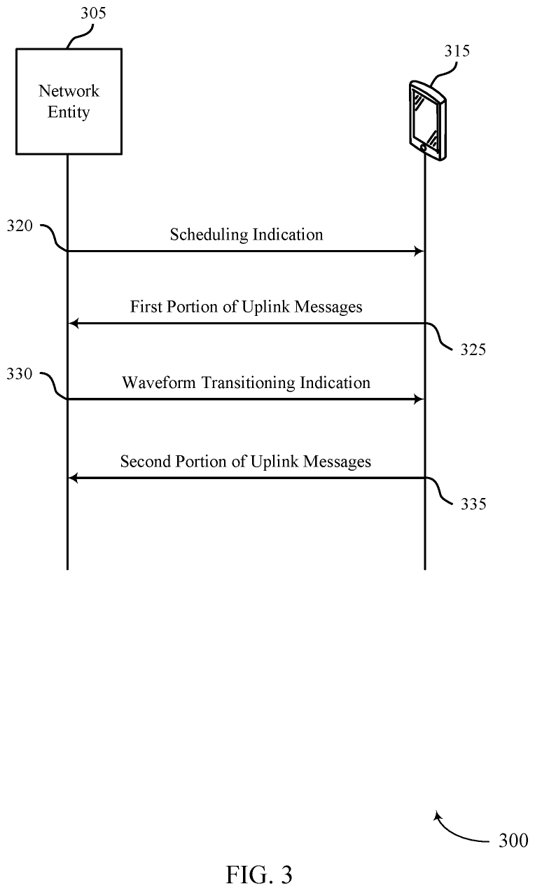

FIG. 3 illustrates an example of a process flow 300 that supports waveform switching for wireless communications in accordance with one or more aspects of the present disclosure. The process flow 300 may implement or be implemented at or using one or more aspects of the wireless communications system 100 and the wireless communications system 200. For example, the process flow 300 may include a UE 315 and a network entity 305, which may be examples of the corresponding devices as described with reference to FIGS. 1 and 2. In the example of FIG. 3, the network entity 305 may be an example of a CU 160, a DU 165, or an RU 170 (or one or more other components of the network entity 305) as described with reference to FIG. 1. In the following description of the process flow 300, operations between the UE 315 and the network entity 305 may occur in a different order or at different times than as shown. Some operations may also be omitted from the process flow 300, and other operations may be added to the process flow 300.

As illustrated in the example of FIG. 3, the UE 315 may be configured to switch waveform types during a time duration for transmitting a set of uplink messages (e.g., for transmitting uplink repetitions). For example, the UE 315 may be configured (e.g., scheduled) to transmit a set of uplink messages (e.g., a set of collectively scheduled uplink messages, a set of repetitions of a PUSCH transmission, or a set of repetitions of a physical uplink control channel (PUCCH) transmission, or any combination thereof). In such an example, the UE 315 may transmit a subset (e.g., a portion) of the configured set of uplink messages (e.g., the repetitions of PUSCH transmission, or the repetitions of the PUCCH transmission, or both) with a waveform type and another subset (e.g., of the configured set of uplink messages) with another waveform type. For example, the UE 315 may transmit a subset of repetitions of the PUSCH transmission (or the PUCCH transmission) with the CP-OFDM waveform and another subset with the DFT-s-OFDM waveform. Additionally, or alternatively, the UE 315 may transmit a subset of repetitions of the PUSCH transmission (or the PUCCH transmission) with a set of parameters (e.g., associated with one of the CP-OFDM waveform or the DFT-s-OFDM waveform) and another subset of the repetitions with another set of parameters (e.g., associated with the same one of the CP-OFDM waveform or the DFT-s-OFDM waveform). That is, the UE 315 may use a same waveform type for both subsets of the repetitions and different sets of parameters. For example, the UE 315 may apply different pulse shaping (e.g., two different pulse shapes) or different filters (or both) for transmission of multiple (e.g., two) subsets of the PUSCH (or the PUCCH) repetitions.

For example, at 320, the UE 315 may receive (e.g., from the network entity 305) first signaling that includes a scheduling indication. The scheduling indication may be an example of a scheduling indication as described with reference to FIG. 2. For example, the scheduling indication may schedule a set of uplink messages for the UE 315. At 325, the UE 315 may transmit a first portion of the set of uplink messages (e.g., scheduled for the UE 315 at 320) in accordance with a first waveform type associated with a first set of parameters. At 330, the UE 315 may receive second signaling that includes a waveform transitioning indication. The waveform transitioning indication may be an example of a waveform transitioning indication as described with reference to FIG. 2. For example, the waveform transitioning indication may indicate for the UE 315 to transition from the first waveform type associated with the first set of parameters to a second waveform type associated with a second set of parameters.

In some examples (e.g., in response to receiving the waveform transitioning indication at 330), the UE 315 may switch the waveform type for remaining uplink messages of the set of uplink messages (e.g., for transmission of remaining PUSCH repetitions). That is, if the waveform transitioning indication (e.g., a dynamic indication of waveform switching) is received between uplink message transmissions (e.g., between PUSCH repetitions) the UE 315 may transition from the first waveform type to the second waveform type (e.g., indicated using the waveform transitioning indication), such that the UE 315 may use the second waveform type for transmitting remaining uplink messages of the set of uplink message (e.g., scheduled using the scheduling indication transmitted from the network entity 305 at 320). In some example, receiving the waveform transition indication (e.g., at the UE 315) may trigger activation of a timer (e.g., a processing timer) at the UE 315. For example, in response to receiving the waveform transitioning indication (e.g., at 330) the UE 315 may apply a processing time (e.g., associated with joint channel estimation) prior to switching waveform types. That is, the UE 315 may transition from the first waveform type to the second waveform type based on an elapsed time since the second signaling is received at the UE satisfying a threshold (e.g., the processing time).

In some examples, an indication (e.g., from the network entity 305) or a determination (e.g., at the UE 315) of joint channel estimation (e.g., to perform channel estimation) may affect a timing of waveform switching (e.g., at the UE 315). For example, the UE 315 may adjust the timing of waveform switching to avoid division (e.g., splitting, breaking) of a PUSCH DMRS bundle (e.g., to avoid waveform switching between repetitions that may be used for joint channel estimation). In such an example, the timing of waveform switching may depend on a time domain window (TDW) for uplink DMRS bundling. For example, the UE 315 may determine that the first portion of the set of uplink messages is associated with the set of reference signals (e.g., DMRSs) for performing channel estimation and, as such, may wait to transition from the first waveform type to the second waveform type until after the UE 315 transmits the first portion of the set of uplink messages (e.g., a PUSCH DMRS bundle). At 335 (e.g., after transitioning from the first waveform type to the second waveform type), the UE 315 may transmit a second portion of the set of uplink messages in accordance with the second waveform type associated with the second set of parameters.

In some examples, use of multiple waveform types (or multiple sets of parameters) for multiple portions (e.g., different subsets) of a set of uplink messages (e.g., a scheduled set of uplink messages) may be based on one or more capabilities of the UE 315. That is, hybrid transmission of uplink messages (e.g., PUSCH repetitions), in which a portion of uplink messages (e.g., a subset of repetitions) may be transmitted with a waveform type and another portion of uplink messages (e.g., another subset of repetitions) may be transmitted with another waveform, may be applied depending on a UE capability. In some examples, the UE 315 may transmit an indication of the UE capability (or multiple UE capabilities) associated with waveform type switching at the UE 315 to the network entity 305. In such examples, the UE 315 may receive the second signaling (e.g., the waveform transitioning indication) based on the indicated UE capability. In some examples, UE capability indications may be transmitted to the network entity 305 (e.g., from the UE 315 or one or more other UEs) per UE, per frequency band, per frequency range, or any combination thereof.

Additionally, or alternatively, hybrid transmission of PUSCH repetitions may be applied depending on a configuration indicated to the UE 315 from the network entity 305 (e.g., a gNB). For example, the UE 315 may receive third signaling indicating that the UE 315 may be allowed to transmit different portions of the set of uplink messages (e.g., scheduled for the UE 315 at 320) in accordance with different waveform types (e.g., perform hybrid transmission of PUSCH repetitions). In such an example, the UE 315 may transmit the second portion of the set of uplink messages in accordance with the second waveform type (e.g., at 335) based on the third signaling (e.g., indicating that the UE is allowed to transmit different portions of the set of uplink messages in accordance with different waveform types). In some examples, the network entity 305 may configure the UE 315 (e.g., to transmit different portions of the set of uplink messages in accordance with different waveform types) using control signaling (e.g., through enabling of a one-bit flag included in RRC signaling). In some examples, such a configuration may be per UE, per frequency band, per frequency range, or any combination thereof. In some examples, configuring the UE 315 to transition (e.g., switch dynamically) between waveform types may increase the reliability of communications between the UE 315 and the network entity 305, among other possible benefits.

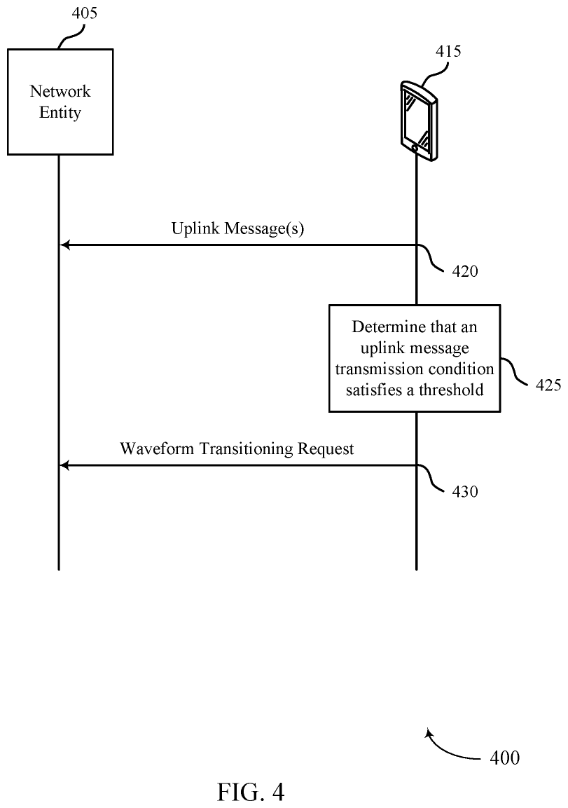

FIG. 4 illustrates an example of a process flow 400 that supports waveform switching for wireless communications in accordance with one or more aspects of the present disclosure. The process flow 400 may implement or be implemented at or using one or more aspects of the wireless communications system 100 and the wireless communications system 200. For example, the process flow 400 may include a UE 415 and a network entity 405, which may be examples of the corresponding devices as described with reference to FIGS. 1 and 2. In the example of FIG. 4, the network entity 405 may be an example of a CU 160, a DU 165, or an RU 170 (or one or more other components of the network entity 405) as described with reference to FIG. 1. In the following description of the process flow 400, operations between the UE 415 and the network entity 405 may occur in a different order or at different times than as shown. Some operations may also be omitted from the process flow 400, and other operations may be added to the process flow 400.

As illustrated in the example of FIG. 4, the UE 415 may request waveform switching for uplink transmission. In some examples, the request may be associated with (e.g., for) switching between a CP-OFDM waveform and a DFT-s-OFDM waveform (or any other type of waveform supported at the UE 415). Additionally, or alternatively, the request may be associated with (e.g., for) switching among different pulse shapes, or filters, or both, among other examples of parameters for transmitting uplink messages.

For example, at 420, the UE 415 may transmit one or more uplink messages in accordance with a first waveform type associated with a first set of parameters. In some examples, the first set of parameters may be an example of a first set of parameters as described with reference to FIG. 2. For example, the first set of parameters may correspond to a first type of modulation or a first type of pulse shape (or both). Additionally, or alternatively, the first set of parameters may include a first set of filtering parameters. At 425, the UE 415 may determine (e.g., based on transmitting the one or more uplink messages at 420) that an uplink message transmission condition satisfies a threshold. The uplink message transmission condition may be an example of an uplink message transmission condition as described with reference to FIG. 2. For example, the uplink message transmission condition may be associated with uplink transmissions at the UE 415. Additionally, or alternatively, the uplink message transmission condition may be an example a power headroom of the UE 415. That is, the UE 415 may determine that a power headroom for the UE has crossed (e.g., become greater than or less than) the threshold. In such an example, the UE 415 may request to transition from the first waveform type to the second waveform type based on determining that the power headroom for the UE 415 has crossed the threshold.

In some examples, the UE 415 may request waveform switching based on a PAPR constraint of the UE 415. Additionally, or alternatively, the UE 415 may request waveform switching based on an average transmit power (e.g., of the uplink messages transmitted at 420), power amplifier nonlinearities, or a power headroom of the UE 415, among other possible examples. That is, the uplink message transmission condition may include a non-linearity metric associated with a power amplifier at the UE 415, a power headroom, a PAPR, an average transmit power, or any combination thereof.

For example, at 430, the UE 415 may transmit a waveform transitioning request to the network entity 405 (e.g., based on the determination at 425). The waveform transitioning request may be an example of a waveform transitioning request as described with reference to FIG. 2. For example, the waveform transitioning request may include a request (e.g., of the UE 415) to transition from the first waveform type associated with the first set of parameters to a second waveform type associated with a second set of parameters. The second set of parameters may be an example of a second set of parameters as described with reference to FIG. 2. For example, the second set of parameters may correspond to a second type of modulation or a second type of pulse shape (or both). Additionally, or alternatively, the second set of parameters may include a second set of filtering parameters.

In some examples, waveform switching (e.g., at the UE 415 in response to transmitting the waveform transitioning request at 430) may be applied to PUSCH transmissions or PUCCH transmissions (or both). Additionally, or alternatively, in some examples, whether the UE 415 may apply waveform switching for PUSCH transmissions or PUCCH transmission (or both) may be based on configuration. For example, the UE 415 may identify a configuration for waveform type selection at the UE 415 and transition from the first waveform type to the second waveform type (e.g., perform waveform switching) in accordance with the configuration and based on transmitting the waveform transitioning request (e.g., transmitted at 430).

For example (e.g., in accordance with the configuration), a request of waveform switching (e.g., the waveform transitioning request transmitted at 430) may be transmitted using a PUCCH or as UCI on a PUSCH. Additionally, or alternatively, the request of waveform switching (e.g., the waveform transitioning request transmitted at 430) may be transmitted using an uplink MAC CE. In some examples, the network entity 405 may determine (e.g., implicitly interpret) a request of waveform switching (e.g., from the UE 415) based on other signaling (e.g., a power headroom of other signals, such as the uplink messages transmitted at 420). Additionally, or alternatively, the request of waveform switching (e.g., the waveform transitioning request transmitted at 430) may be indicated (e.g., from the UE 415) per frequency range, per frequency band, per bandwidth part, per carrier component, or any combination thereof.

In some examples, a request of waveform switching (e.g., the waveform transitioning request transmitted at 430) may be granted through an indication from the network entity 405 (e.g., the gNB) to the UE 415. For example, the UE 415 may receive (e.g., in response to transmitting the waveform transitioning request at 430), a grant to transition from the first waveform type to the second waveform type. In such an example, the UE 415 may transition from the first waveform type to the second waveform type based on receiving the grant. Additionally, or alternatively, a request of waveform switching (e.g., the waveform transitioning request transmitted at 430) may be granted (e.g., automatically) after a time duration. For example, the UE 415 may transmit the request in accordance with the configuration, which may include a time duration associated with transitioning between waveform types. In some examples, the time duration may be measured from a time at which the UE 415 transmits the waveform transitioning request (e.g., at 430). In such an example, transitioning from the first waveform type to the second waveform type may occur after (e.g., at least) the time duration has elapsed since transmitting the waveform transitioning request (e.g., at 430).

In some examples, grant of a waveform switching request (e.g., the waveform transitioning request) may be conditioned on a permission (e.g., a configured permission) from the network entity 405 (e.g., the gNB,), such as through RRC signaling. In some examples, the grant may be based on one or more criteria (e.g., configured criteria) that may include thresholds (e.g., configured thresholds) on reported values or measurement of parameters (e.g., transmission parameters) associated with the UE 415 (e.g., a reported power headroom). In some examples, transmitting a request to switch waveform types (e.g., transition from the first waveform type to the second waveform type) may increase the reliability of communications between the UE 415 and the network entity 405, among other possible benefits.

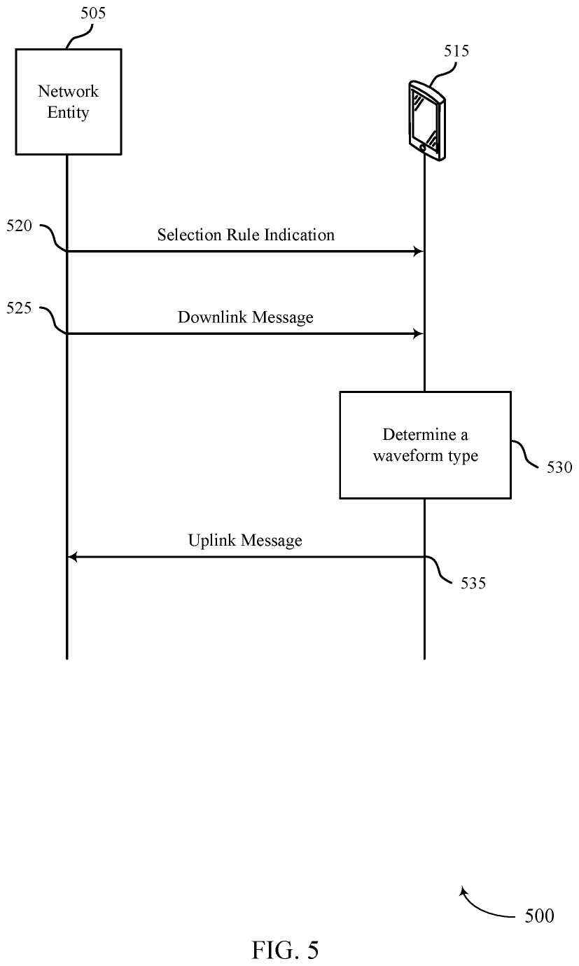

FIG. 5 illustrates an example of a process flow 500 that supports waveform switching for wireless communications in accordance with one or more aspects of the present disclosure. The process flow 500 may implement or be implemented at or using one or more aspects of the wireless communications system 100 and the wireless communications system 200. For example, the process flow 500 may include a UE 515 and a network entity 505, which may be examples of the corresponding devices as described with reference to FIGS. 1 and 2. In the example of FIG. 5, the network entity 505 may be an example of a CU 160, a DU 165, or an RU 170 (or one or more other components of the network entity 505) as described with reference to FIG. 1. In the following description of the process flow 500, operations between the UE 515 and the network entity 505 may occur in a different order or at different times than as shown. Some operations may also be omitted from the process flow 500, and other operations may be added to the process flow 500.

As illustrated in the example of FIG. 5, the UE 515 may be configured (e.g., using an indication transmitted from the network entity 505) with a rule for selecting a waveform type during a random access procedure (e.g., a CFRA). For example, the network entity 505 (e.g., a gNB) may configure the UE 515 UE (e.g., using RRC signaling) to determine a waveform type (e.g., a CFRA PUSCH waveform) based on content included a message transmitted from the network entity 505 during a random access procedure (e.g., a Msg2, a Msg2 PDCCH, or both). That is, determination of a waveform type for transmitting uplink messages (e.g., a CFRA PUSCH waveform) may be through an interpretation of a downlink message (e.g., a bitfield of a downlink message) transmitted from the network entity 505 during a random access procedure (e.g., the Msg2, the Msg2 PDCCH, or both). In some examples, the interpretation may be based on a configuration (e.g., an RRC configuration), for example indicated to the UE 515 from the network entity 505.

For example, at 520, the UE 515 may receive first signaling including a selection rule indication. The selection rule indication may be an example of a selection rule indication as described with reference to FIG. 2. For example, the selection rule indication may be indicative of a rule pertaining to waveform type selection for a type of uplink message (e.g., a CFRA PUSCH) included in a random access procedure. In some examples, the rule may be associated with information within a type of downlink message (e.g., the Msg2 or the Msg2 PDCCH) included in the random access procedure.

At 525, the UE 515 may receive (e.g., during the random access procedure) the information within a downlink message of the type of downlink message. For example, (e.g., at 525), the UE 515 may receive a downlink message which may be a second message of a random access procedure (e.g., the Msg2, the Msg2 PDCCH) and may include the information for which the rule (e.g., indicated using the selection rule indication transmitted at 520) pertains. At 530, the UE 515 may determine a waveform type for an uplink message (e.g., of the type of uplink message or another type of uplink message) based on the information included in the downlink message (e.g., transmitted at 525) and the rule (e.g., indicated using the selection rule indication transmitted at 520). At 535, the UE 515 may transmit (e.g., during the random access procedure), the uplink message (e.g., a CFRA PUSCH) using the determined waveform type.

In some examples, waveform switching for the uplink message transmitted at 535 (e.g., dynamic waveform switching for a CFRA PUSCH), or interpretation of the downlink message received at 525 (e.g., interpretation of the Msg2 bitfield for a waveform switching indication), may be applicable (e.g., to the UE 515) depending on a use case of the random access procedure (e.g., the CFRA), such as whether the random access procedure may be performed at the UE 515 for beam failure recovery (e.g., as part of a beam failure recover procedure) or for handover (e.g., as part of a handover procedure). Additionally, or alternatively, waveform switching for the uplink message transmitted at 535 (e.g., dynamic waveform switching for a CFRA PUSCH), or interpretation of the downlink message received at 525 (e.g., interpretation of the Msg2 bitfield for a waveform switching indication), may be condition on a request from the UE 515. For example, the UE 515 may transmit an indication of a request to transition from a first waveform type to a second waveform type for the type of uplink message. In such an example, the UE 515 may receive the selection rule indication (e.g., at 520) based on transmitting the request.

In some examples, the request to transition from the first waveform type to the second waveform type for the type of uplink message (e.g., the request for dynamic waveform switching) may be indicated using one or more particular RACH occasions (e.g., a different RACH occasion than may be configured for the UE 515 to transmit a PRACH preamble). That is, the UE 515 may indicate a request to transition from the first waveform type to the second waveform type through transmission of a random access preamble (e.g., a same CFRA PRACH preamble as may be configured for the UE 515) using one or more particular RACH occasions. Additionally, or alternatively, the request to transition from the first waveform type to the second waveform type for the type of uplink message (e.g., the request for dynamic waveform switching) may be indicated using one or more particular frequency resources (e.g., of the PRACH) or a particular bandwidth part (or both) for transmitting the random access preamble (e.g., the PRACH transmission).

In some examples, the request to transition from the first waveform type to the second waveform type for the type of uplink message (e.g., the request for dynamic waveform switching) may be linked to a repetition of a random access preamble (e.g., a PRACH repetition). For example, a request from the UE 515 transition from the first waveform type to the second waveform type (e.g., for CFRA PUSCH waveform switching) may be conditioned on a threshold, a received power of a synchronization signal (e.g., a synchronization signal reference signal received power (SS-RSRP)), or one or more other measurements performed at the UE 515, among other possible examples. In some examples, the threshold may be configured for the UE 515 using RRC signaling. Additionally, or alternatively, the threshold may be different for different applications of the uplink message (e.g., the CFRA PUSCH), such as whether the random access procedure is for handover or beam failure recovery.

Additionally, or alternatively, the request to transition from the first waveform type to the second waveform type for the type of uplink message (e.g., the request for dynamic waveform switching) may be applicable depending on a capability of the UE 515, which may be indicated to the network entity 505 as part of a UE capability indication. For example, the UE 515 may transmit an indication of a capability (e.g., a UE capability) associated with waveform type selection at the UE 515 to the network entity 505. In such an example, the UE 515 may receive the first signaling (e.g., including the selection rule indication) based on the UE capability. In some examples, the UE capability for waveform switching (e.g., for the uplink message type, for the CFRA PUSCH) may be indicated per frequency range, per frequency band, per frequency band combination, per bandwidth part, per carrier component, or per use case scenario (e.g., of the random access procedure), or any combination thereof.

In some examples, based on the request to transition from the first waveform type to the second waveform type for the type of uplink message (e.g., the request for dynamic waveform switching, the UE 515 may use a different waveform type for the uplink message transmitting at 535 (e.g., a Msg3 of the CFRA), for another uplink message (or multiple other uplink messages) transmitted from the UE 515 as part of another (e.g., a subsequent) random access procedure, or for any other uplink communications transmitted from the UE 515 (e.g., subsequent to transmitting the request). That is, the waveform type determined at the UE 515 at 530 may be used for a next uplink message (e.g., the uplink message transmitted at 535) or for any subsequent uplink message transmitted from the UE 515. In some examples, configuring the UE 515 with a rule for selecting a waveform type during a random access procedure may increase the reliability of communications between the UE 515 and the network entity 505, among other possible benefits.

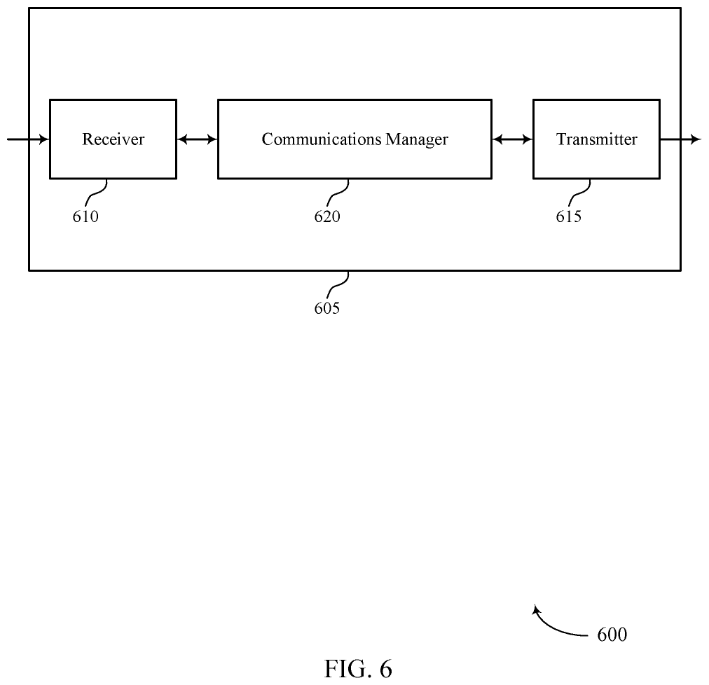

FIG. 6 shows a block diagram 600 of a device 605 that supports waveform switching for wireless communications in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to waveform switching for wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to waveform switching for wireless communications). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of waveform switching for wireless communications as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE (e.g., the device 605) in accordance with examples as disclosed herein. For example, the communications manager 620 may be configured as or otherwise support a means for receiving first signaling that schedules a set of uplink messages for the UE. The communications manager 620 may be configured as or otherwise support a means for transmitting a first portion of the set of uplink messages in accordance with a first waveform type associated with a first set of parameters. The communications manager 620 may be configured as or otherwise support a means for receiving second signaling that indicates for the UE to transition from the first waveform type associated with the first set of parameters to a second waveform type associated with a second set of parameters. The communications manager 620 may be configured as or otherwise support a means for transmitting a second portion of the set of uplink messages in accordance with the second waveform type associated with the second set of parameters.

Additionally, or alternatively, the communications manager 620 may support wireless communication at a UE (e.g., the device 605) in accordance with examples as disclosed herein. For example, the communications manager 620 may be configured as or otherwise support a means for transmitting one or more uplink messages in accordance with a first waveform type associated with a first set of parameters, where the first set of parameters correspond to a first type of modulation, correspond to a first type of pulse shape, include a first set of filtering parameters, or any combination thereof. The communications manager 620 may be configured as or otherwise support a means for determining, based on transmitting the one or more uplink messages, that a condition associated with uplink transmissions at the UE satisfies a threshold. The communications manager 620 may be configured as or otherwise support a means for transmitting, based on the determination, a request to transition from the first waveform type associated with the first set of parameters to a second waveform type associated with a second set of parameters, where the second set of parameters correspond to a second type of modulation, correspond to a second type of pulse shape, include a second set of filtering parameters, or any combination thereof.

Additionally, or alternatively, the communications manager 620 may support wireless communication at a UE (e.g., the device 605) in accordance with examples as disclosed herein. For example, the communications manager 620 may be configured as or otherwise support a means for receiving first signaling indicative of a rule pertaining to waveform type selection for a type of uplink message included in a random access procedure, the rule associated with information within a type of downlink message included in the random access procedure. The communications manager 620 may be configured as or otherwise support a means for receiving, during the random access procedure, the information within a downlink message of the type of downlink message. The communications manager 620 may be configured as or otherwise support a means for determining a waveform type for an uplink message of the type of uplink message based on the information included in the downlink message and the rule. The communications manager 620 may be configured as or otherwise support a means for transmitting, during the random access procedure, the uplink message using the determined waveform type.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing, reduced power consumption, and more efficient utilization of communication resources.

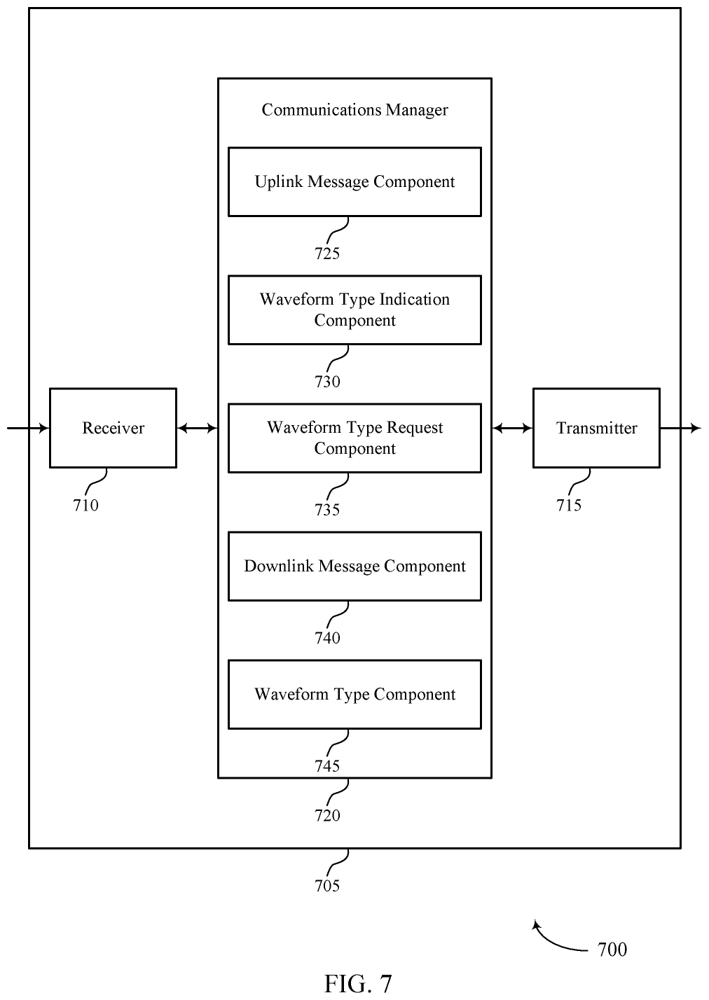

FIG. 7 shows a block diagram 700 of a device 705 that supports waveform switching for wireless communications in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to waveform switching for wireless communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to waveform switching for wireless communications). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of waveform switching for wireless communications as described herein. For example, the communications manager 720 may include an uplink message component 725, a waveform type indication component 730, a waveform type request component 735, a downlink message component 740, a waveform type component 745, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE (e.g., the device 705) in accordance with examples as disclosed herein. The uplink message component 725 may be configured as or otherwise support a means for receiving first signaling that schedules a set of uplink messages for the UE. The uplink message component 725 may be configured as or otherwise support a means for transmitting a first portion of the set of uplink messages in accordance with a first waveform type associated with a first set of parameters. The waveform type indication component 730 may be configured as or otherwise support a means for receiving second signaling that indicates for the UE to transition from the first waveform type associated with the first set of parameters to a second waveform type associated with a second set of parameters. The uplink message component 725 may be configured as or otherwise support a means for transmitting a second portion of the set of uplink messages in accordance with the second waveform type associated with the second set of parameters.

Additionally, or alternatively, the communications manager 720 may support wireless communication at a UE (e.g., the device 705) in accordance with examples as disclosed herein. The uplink message component 725 may be configured as or otherwise support a means for transmitting one or more uplink messages in accordance with a first waveform type associated with a first set of parameters, where the first set of parameters correspond to a first type of modulation, correspond to a first type of pulse shape, include a first set of filtering parameters, or any combination thereof. The uplink message component 725 may be configured as or otherwise support a means for determining, based on transmitting the one or more uplink messages, that a condition associated with uplink transmissions at the UE satisfies a threshold. The waveform type request component 735 may be configured as or otherwise support a means for transmitting, based on the determination, a request to transition from the first waveform type associated with the first set of parameters to a second waveform type associated with a second set of parameters, where the second set of parameters correspond to a second type of modulation, correspond to a second type of pulse shape, include a second set of filtering parameters, or any combination thereof.

Additionally, or alternatively, the communications manager 720 may support wireless communication at a UE (e.g., the device 705) in accordance with examples as disclosed herein. The uplink message component 725 may be configured as or otherwise support a means for receiving first signaling indicative of a rule pertaining to waveform type selection for a type of uplink message included in a random access procedure, the rule associated with information within a type of downlink message included in the random access procedure. The downlink message component 740 may be configured as or otherwise support a means for receiving, during the random access procedure, the information within a downlink message of the type of downlink message. The waveform type component 745 may be configured as or otherwise support a means for determining a waveform type for an uplink message of the type of uplink message based on the information included in the downlink message and the rule. The uplink message component 725 may be configured as or otherwise support a means for transmitting, during the random access procedure, the uplink message using the determined waveform type.

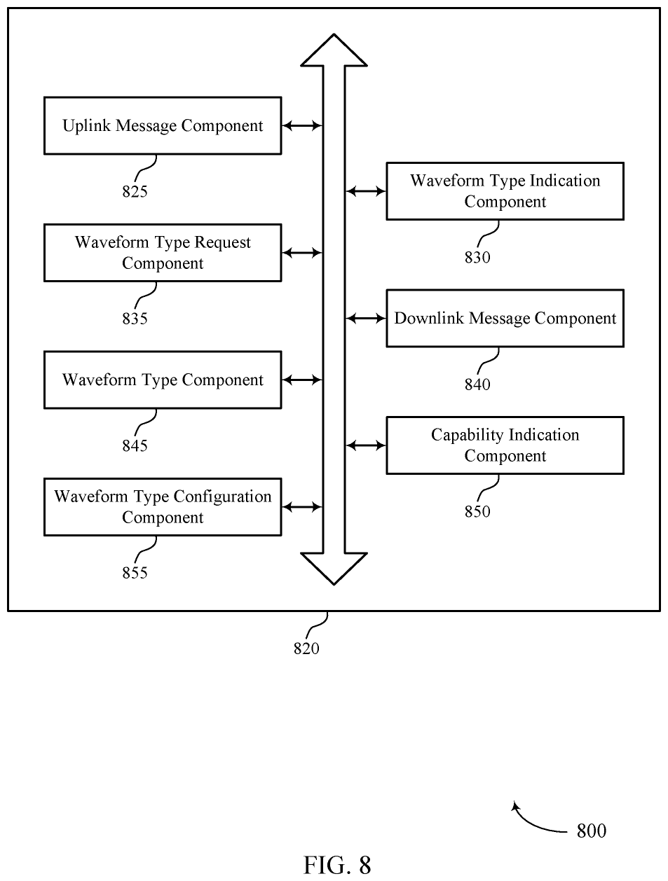

FIG. 8 shows a block diagram 800 of a communications manager 820 that supports waveform switching for wireless communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of waveform switching for wireless communications as described herein. For example, the communications manager 820 may include an uplink message component 825, a waveform type indication component 830, a waveform type request component 835, a downlink message component 840, a waveform type component 845, a capability indication component 850, a waveform type configuration component 855, or any combination thereof. Each of these components may communicate, directly or indirectly, with one another (e.g., via one or more buses).

The communications manager 820 may support wireless communication at a UE in accordance with examples as disclosed herein. The uplink message component 825 may be configured as or otherwise support a means for receiving first signaling that schedules a set of uplink messages for the UE. In some examples, the uplink message component 825 may be configured as or otherwise support a means for transmitting a first portion of the set of uplink messages in accordance with a first waveform type associated with a first set of parameters. The waveform type indication component 830 may be configured as or otherwise support a means for receiving second signaling that indicates for the UE to transition from the first waveform type associated with the first set of parameters to a second waveform type associated with a second set of parameters. In some examples, the uplink message component 825 may be configured as or otherwise support a means for transmitting a second portion of the set of uplink messages in accordance with the second waveform type associated with the second set of parameters.

In some examples, the second signaling is received after transmitting at least one uplink message included in the first portion of the set of uplink messages, and the waveform type indication component 830 may be configured as or otherwise support a means for transitioning from the first waveform type to the second waveform type based on an elapsed time since the second signaling is received at the UE satisfying a threshold, where transmitting the second portion of the set of uplink messages in accordance with the second waveform type is based on the transitioning.

In some examples, the uplink message component 825 may be configured as or otherwise support a means for determining that the first portion of the set of uplink messages is associated with a set of reference signals for performing channel estimation. In some examples, the waveform type component 845 may be configured as or otherwise support a means for waiting to transition from the first waveform type to the second waveform type until after transmitting the first portion of the set of uplink messages, the waiting based on the determination that the first portion of the set of uplink messages is associated with the set of reference signals for performing channel estimation.

In some examples, the waveform type indication component 830 may be configured as or otherwise support a means for receiving third signaling indicating that the UE is allowed to transmit different portions of the set of uplink messages in accordance with different waveform types, where transmitting the second portion of the set of uplink messages in accordance with the second waveform type is based on the third signaling indicating that the UE is allowed to transmit different portions of the set of uplink messages in accordance with different waveform types.

In some examples, the capability indication component 850 may be configured as or otherwise support a means for transmitting an indication of a UE capability associated with waveform type switching at the UE, where receiving the second signaling indicating for the UE to transition from the first waveform type to the second waveform type is based on the UE capability. In some examples, the UE capability is based on one or more frequencies configured for the wireless communication.

Additionally, or alternatively, the communications manager 820 may support wireless communication at a UE in accordance with examples as disclosed herein. In some examples, the uplink message component 825 may be configured as or otherwise support a means for transmitting one or more uplink messages in accordance with a first waveform type associated with a first set of parameters, where the first set of parameters correspond to a first type of modulation, correspond to a first type of pulse shape, include a first set of filtering parameters, or any combination thereof. In some examples, the uplink message component 825 may be configured as or otherwise support a means for determining, based on transmitting the one or more uplink messages, that a condition associated with uplink transmissions at the UE satisfies a threshold. The waveform type request component 835 may be configured as or otherwise support a means for transmitting, based on the determination, a request to transition from the first waveform type associated with the first set of parameters to a second waveform type associated with a second set of parameters, where the second set of parameters correspond to a second type of modulation, correspond to a second type of pulse shape, include a second set of filtering parameters, or any combination thereof.

In some examples, to support determining that the condition associated with uplink transmissions at the UE satisfies the threshold, the waveform type request component 835 may be configured as or otherwise support a means for determining that a power headroom for the UE has crossed the threshold, where transmitting the request to transition from the first waveform type to the second waveform type is based on determining that the power headroom for the UE has crossed the threshold.

In some examples, the waveform type component 845 may be configured as or otherwise support a means for receiving, in response to transmitting the request, a grant to transition from the first waveform type to the second waveform type. In some examples, the waveform type component 845 may be configured as or otherwise support a means for transitioning from the first waveform type to the second waveform type based on receiving the grant.

In some examples, the waveform type configuration component 855 may be configured as or otherwise support a means for identifying a configuration for waveform type selection at the UE. In some examples, the waveform type component 845 may be configured as or otherwise support a means for transitioning from the first waveform type to the second waveform type in accordance with the configuration and based on transmitting the request.

In some examples, the configuration indicates whether the UE is allowed to transition between waveform types for one or more types of uplink messages. In some examples, transitioning from the first waveform type to the second waveform type is based on the one or more uplink messages including a type of uplink messages included in the one or more types of uplink messages. In some examples, the configuration includes a threshold for transitioning between waveform types. In some examples, the condition includes the threshold being satisfied by one or more metrics associated with uplink transmissions by the UE.

In some examples, the configuration includes a time duration associated with transitioning between waveform types. In some examples, the time duration is measured from a time at which the UE transmits the request. In some examples, transitioning from the first waveform type to the second waveform type occurs after at least the time duration has elapsed since transmitting the request. In some examples, the condition includes a non-linearity metric associated with a power amplifier at the UE, a power headroom, a PAPR, an average transmit power, or any combination thereof.

Additionally, or alternatively, the communications manager 820 may support wireless communication at a UE in accordance with examples as disclosed herein. In some examples, the uplink message component 825 may be configured as or otherwise support a means for receiving first signaling indicative of a rule pertaining to waveform type selection for a type of uplink message included in a random access procedure, the rule associated with information within a type of downlink message included in the random access procedure. The downlink message component 840 may be configured as or otherwise support a means for receiving, during the random access procedure, the information within a downlink message of the type of downlink message. The waveform type component 845 may be configured as or otherwise support a means for determining a waveform type for an uplink message of the type of uplink message based on the information included in the downlink message and the rule. In some examples, the uplink message component 825 may be configured as or otherwise support a means for transmitting, during the random access procedure, the uplink message using the determined waveform type.

In some examples, to support determining the waveform type based on the information included in the downlink message and the rule, the downlink message component 840 may be configured as or otherwise support a means for interpreting a bitfield of the downlink message in accordance with the rule, the bitfield including the information. In some examples, to support determining the waveform type based on the information included in the downlink message and the rule, the waveform type component 845 may be configured as or otherwise support a means for determining the waveform type based on the interpretation of the bitfield.

In some examples, the waveform type component 845 may be configured as or otherwise support a means for performing the random access procedure as part of a beam failure recovery procedure or a handover procedure, where determining the waveform type is based on the random access procedure being performed as part of the beam failure recovery procedure or the handover procedure.

In some examples, the waveform type request component 835 may be configured as or otherwise support a means for transmitting an indication of a request to transition from a first waveform type to a second waveform type for the type of uplink message, where receiving the first signaling is based on transmitting the request.

In some examples, to support transmitting the request to transition from the first waveform type to the second waveform type, the waveform type request component 835 may be configured as or otherwise support a means for transmitting a random access preamble via a random access occasion, where the request is indicated by the random access occasion, a sequence associated with the random access preamble, or both. In some examples, to support transmitting the request to transition from the first waveform type to the second waveform type, the waveform type request component 835 may be configured as or otherwise support a means for transmitting a random access preamble over one or more frequency resources, where the request is indicated by the one or more frequency resources, a bandwidth part associated with the one or more frequency resources, or both. In some examples, to support transmitting the request to transition from the first waveform type to the second waveform type, the waveform type request component 835 may be configured as or otherwise support a means for transmitting a set of two or more random access preambles, where the request is indicated by the set of two or more random access preambles.

In some examples, the capability indication component 850 may be configured as or otherwise support a means for transmitting an indication of a UE capability associated with waveform type selection at the UE, where receiving the first signaling is based on the UE capability.

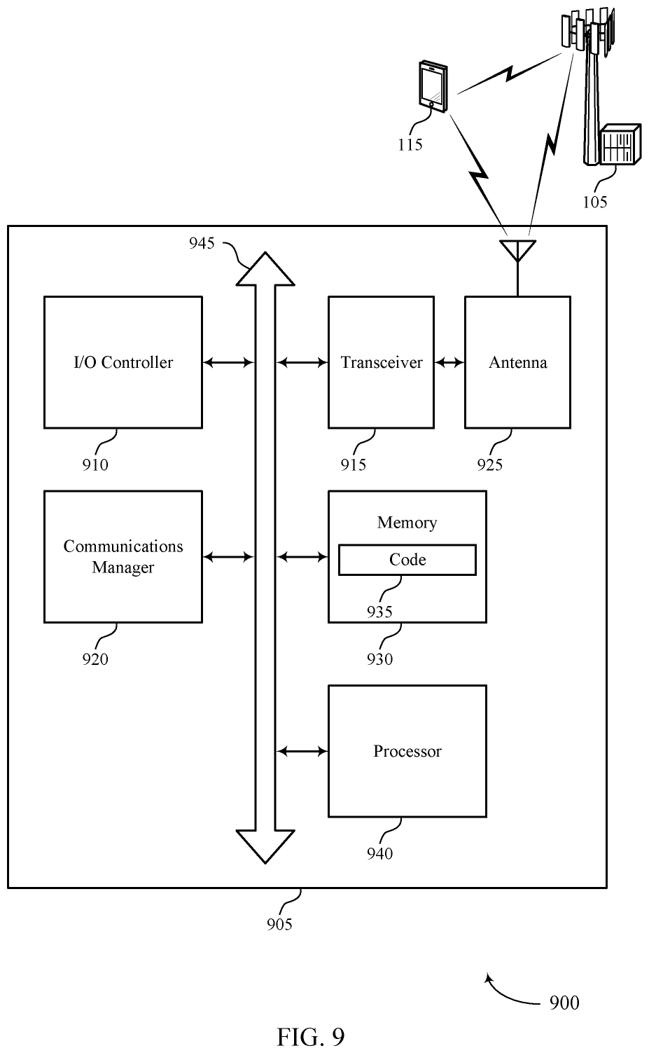

FIG. 9 shows a diagram of a system 900 including a device 905 that supports waveform switching for wireless communications in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting waveform switching for wireless communications). For example, the device 905 or a component of the device 905 may include a processor 940 and memory 930 coupled with or to the processor 940, the processor 940 and memory 930 configured to perform various functions described herein.

The communications manager 920 may support wireless communication at a UE (e.g., the device 905) in accordance with examples as disclosed herein. For example, the communications manager 920 may be configured as or otherwise support a means for receiving first signaling that schedules a set of uplink messages for the UE. The communications manager 920 may be configured as or otherwise support a means for transmitting a first portion of the set of uplink messages in accordance with a first waveform type associated with a first set of parameters. The communications manager 920 may be configured as or otherwise support a means for receiving second signaling that indicates for the UE to transition from the first waveform type associated with the first set of parameters to a second waveform type associated with a second set of parameters. The communications manager 920 may be configured as or otherwise support a means for transmitting a second portion of the set of uplink messages in accordance with the second waveform type associated with the second set of parameters.

Additionally, or alternatively, the communications manager 920 may support wireless communication at a UE (e.g., the device 905) in accordance with examples as disclosed herein. For example, the communications manager 920 may be configured as or otherwise support a means for transmitting one or more uplink messages in accordance with a first waveform type associated with a first set of parameters, where the first set of parameters correspond to a first type of modulation, correspond to a first type of pulse shape, include a first set of filtering parameters, or any combination thereof. The communications manager 920 may be configured as or otherwise support a means for determining, based on transmitting the one or more uplink messages, that a condition associated with uplink transmissions at the UE satisfies a threshold. The communications manager 920 may be configured as or otherwise support a means for transmitting, based on the determination, a request to transition from the first waveform type associated with the first set of parameters to a second waveform type associated with a second set of parameters, where the second set of parameters correspond to a second type of modulation, correspond to a second type of pulse shape, include a second set of filtering parameters, or any combination thereof.

Additionally, or alternatively, the communications manager 920 may support wireless communication at a UE (e.g., the device 905) in accordance with examples as disclosed herein. For example, the communications manager 920 may be configured as or otherwise support a means for receiving first signaling indicative of a rule pertaining to waveform type selection for a type of uplink message included in a random access procedure, the rule associated with information within a type of downlink message included in the random access procedure. The communications manager 920 may be configured as or otherwise support a means for receiving, during the random access procedure, the information within a downlink message of the type of downlink message. The communications manager 920 may be configured as or otherwise support a means for determining a waveform type for an uplink message of the type of uplink message based on the information included in the downlink message and the rule. The communications manager 920 may be configured as or otherwise support a means for transmitting, during the random access procedure, the uplink message using the determined waveform type.

By including or configuring the communications manager 920 in accordance with examples as described herein, the device 905 may support techniques for improved communication reliability, reduced latency, improved user experience related to reduced processing, reduced power consumption, more efficient utilization of communication resources, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. For example, the communications manager 920 may be configured to receive or transmit messages or other signaling as described herein via the transceiver 915. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of waveform switching for wireless communications as described herein, or the processor 940 and the memory 930 may be otherwise configured to perform or support such operations.

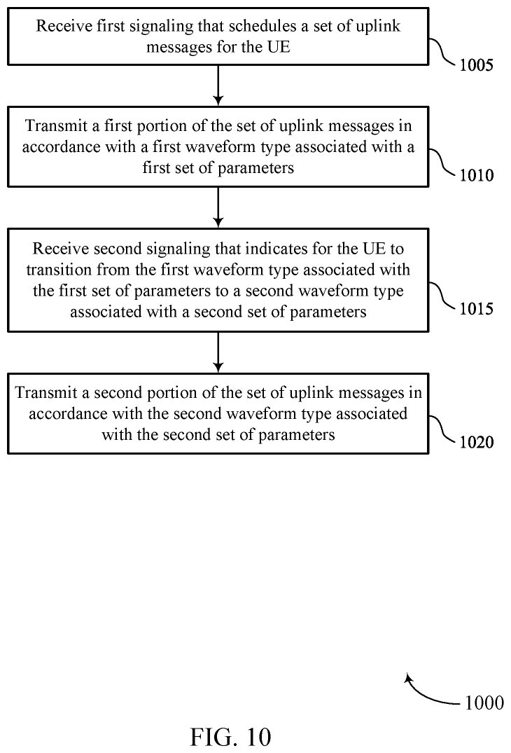

FIG. 10 shows a flowchart illustrating a method 1000 that supports waveform switching for wireless communications in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving first signaling that schedules a set of uplink messages for the UE. The operations of 1005 may be performed in accordance with examples as disclosed herein, for example, in accordance with 320 with reference to FIG. 3. In some examples, aspects of the operations of 1005 may be performed by an uplink message component 825 as described with reference to FIG. 8. Additionally, or alternatively, means for performing 1005 may, but not necessarily, include, for example, antenna 925, transceiver 915, communications manager 920, memory 930 (including code 935), processor 940 and/or bus 945.

At 1010, the method may include transmitting a first portion of the set of uplink messages in accordance with a first waveform type associated with a first set of parameters. The operations of 1010 may be performed in accordance with examples as disclosed herein, for example, in accordance with 325 with reference to FIG. 3. In some examples, aspects of the operations of 1010 may be performed by an uplink message component 825 as described with reference to FIG. 8. Additionally, or alternatively, means for performing 1010 may, but not necessarily, include, for example, antenna 925, transceiver 915, communications manager 920, memory 930 (including code 935), processor 940 and/or bus 945.

At 1015, the method may include receiving second signaling that indicates for the UE to transition from the first waveform type associated with the first set of parameters to a second waveform type associated with a second set of parameters. The operations of 1015 may be performed in accordance with examples as disclosed herein, for example, in accordance with 330 with reference to FIG. 3. In some examples, aspects of the operations of 1015 may be performed by a waveform type indication component 830 as described with reference to FIG. 8. Additionally, or alternatively, means for performing 1015 may, but not necessarily, include, for example, antenna 925, transceiver 915, communications manager 920, memory 930 (including code 935), processor 940 and/or bus 945.

At 1020, the method may include transmitting a second portion of the set of uplink messages in accordance with the second waveform type associated with the second set of parameters. The operations of 1020 may be performed in accordance with examples as disclosed herein, for example, in accordance with 335 with reference to FIG. 3. In some examples, aspects of the operations of 1020 may be performed by an uplink message component 825 as described with reference to FIG. 8. Additionally, or alternatively, means for performing 1020 may, but not necessarily, include, for example, antenna 925, transceiver 915, communications manager 920, memory 930 (including code 935), processor 940 and/or bus 945.

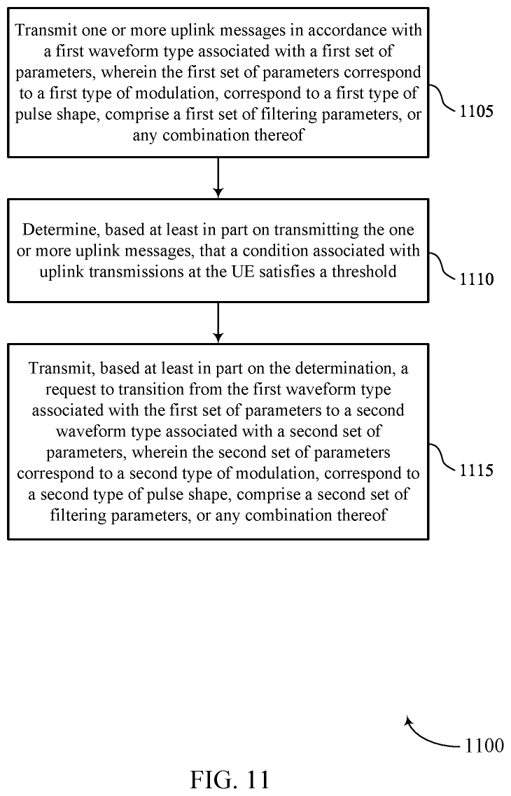

FIG. 11 shows a flowchart illustrating a method 1100 that supports waveform switching for wireless communications in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include transmitting one or more uplink messages in accordance with a first waveform type associated with a first set of parameters, where the first set of parameters correspond to a first type of modulation, correspond to a first type of pulse shape, include a first set of filtering parameters, or any combination thereof. The operations of 1105 may be performed in accordance with examples as disclosed herein, for example, in accordance with 420 with reference to FIG. 4. In some examples, aspects of the operations of 1105 may be performed by an uplink message component 825 as described with reference to FIG. 8. Additionally, or alternatively, means for performing 1105 may, but not necessarily, include, for example, antenna 925, transceiver 915, communications manager 920, memory 930 (including code 935), processor 940 and/or bus 945.

At 1110, the method may include determining, based on transmitting the one or more uplink messages, that a condition associated with uplink transmissions at the UE satisfies a threshold. The operations of 1110 may be performed in accordance with examples as disclosed herein, for example, in accordance with 425 with reference to FIG. 4. In some examples, aspects of the operations of 1110 may be performed by an uplink message component 825 as described with reference to FIG. 8. Additionally, or alternatively, means for performing 1110 may, but not necessarily, include, for example, antenna 925, transceiver 915, communications manager 920, memory 930 (including code 935), processor 940 and/or bus 945.

At 1115, the method may include transmitting, based on the determination, a request to transition from the first waveform type associated with the first set of parameters to a second waveform type associated with a second set of parameters, where the second set of parameters correspond to a second type of modulation, correspond to a second type of pulse shape, include a second set of filtering parameters, or any combination thereof. The operations of 1115 may be performed in accordance with examples as disclosed herein, for example, in accordance with 430 with reference to FIG. 4. In some examples, aspects of the operations of 1115 may be performed by a waveform type request component 835 as described with reference to FIG. 8. Additionally, or alternatively, means for performing 1115 may, but not necessarily, include, for example, antenna 925, transceiver 915, communications manager 920, memory 930 (including code 935), processor 940 and/or bus 945.

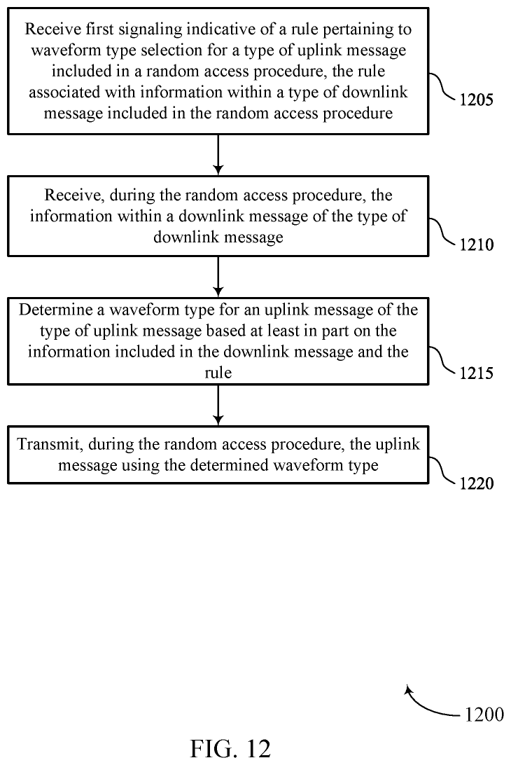

FIG. 12 shows a flowchart illustrating a method 1200 that supports waveform switching for wireless communications in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include receiving first signaling indicative of a rule pertaining to waveform type selection for a type of uplink message included in a random access procedure, the rule associated with information within a type of downlink message included in the random access procedure. The operations of 1205 may be performed in accordance with examples as disclosed herein, for example, in accordance with 520 with reference to FIG. 5. In some examples, aspects of the operations of 1205 may be performed by an uplink message component 825 as described with reference to FIG. 8. Additionally, or alternatively, means for performing 1205 may, but not necessarily, include, for example, antenna 925, transceiver 915, communications manager 920, memory 930 (including code 935), processor 940 and/or bus 945.

At 1210, the method may include receiving, during the random access procedure, the information within a downlink message of the type of downlink message. The operations of 1210 may be performed in accordance with examples as disclosed herein, for example, in accordance with 525 with reference to FIG. 5. In some examples, aspects of the operations of 1210 may be performed by a downlink message component 840 as described with reference to FIG. 8. Additionally, or alternatively, means for performing 1210 may, but not necessarily, include, for example, antenna 925, transceiver 915, communications manager 920, memory 930 (including code 935), processor 940 and/or bus 945.

At 1215, the method may include determining a waveform type for an uplink message of the type of uplink message based on the information included in the downlink message and the rule. The operations of 1215 may be performed in accordance with examples as disclosed herein, for example, in accordance with 530 with reference to FIG. 5. In some examples, aspects of the operations of 1215 may be performed by a waveform type component 845 as described with reference to FIG. 8. Additionally, or alternatively, means for performing 1215 may, but not necessarily, include, for example, antenna 925, transceiver 915, communications manager 920, memory 930 (including code 935), processor 940 and/or bus 945.

At 1220, the method may include transmitting, during the random access procedure, the uplink message using the determined waveform type. The operations of 1220 may be performed in accordance with examples as disclosed herein, for example, in accordance with 535 with reference to FIG. 5. In some examples, aspects of the operations of 1220 may be performed by an uplink message component 825 as described with reference to FIG. 8. Additionally, or alternatively, means for performing 1210 may, but not necessarily, include, for example, antenna 925, transceiver 915, communications manager 920, memory 930 (including code 935), processor 940 and/or bus 945.

The following provides an overview of aspects of the present disclosure:
Aspect 1: A method for wireless communication at a UE, comprising: receiving first signaling that schedules a set of uplink messages for the UE; transmitting a first portion of the set of uplink messages in accordance with a first waveform type associated with a first set of parameters; receiving second signaling that indicates for the UE to transition from the first waveform type associated with the first set of parameters to a second waveform type associated with a second set of parameters; and transmitting a second portion of the set of uplink messages in accordance with the second waveform type associated with the second set of parameters.
Aspect 2: The method of aspect 1, wherein the second signaling is received after transmitting at least one uplink message included in the first portion of the set of uplink messages, the method further comprising: transitioning from the first waveform type to the second waveform type based at least in part on an elapsed time since the second signaling is received at the UE satisfying a threshold, wherein transmitting the second portion of the set of uplink messages in accordance with the second waveform type is based at least in part on the transitioning.
Aspect 3: The method of any of aspects 1 through 2, further comprising: determining that the first portion of the set of uplink messages is associated with a set of reference signals for performing channel estimation; and waiting to transition from the first waveform type to the second waveform type until after transmitting the first portion of the set of uplink messages, the waiting based at least in part on the determination that the first portion of the set of uplink messages is associated with the set of reference signals for performing channel estimation.
Aspect 4: The method of any of aspects 1 through 3, further comprising: receiving third signaling indicating that the UE is allowed to transmit different portions of the set of uplink messages in accordance with different waveform types, wherein transmitting the second portion of the set of uplink messages in accordance with the second waveform type is based at least in part on the third signaling indicating that the UE is allowed to transmit different portions of the set of uplink messages in accordance with different waveform types.
Aspect 5: The method of any of aspects 1 through 4, further comprising: transmitting an indication of a UE capability associated with waveform type switching at the UE, wherein receiving the second signaling indicating for the UE to transition from the first waveform type to the second waveform type is based at least in part on the UE capability.
Aspect 6: The method of aspect 5, wherein the UE capability is based at least in part on one or more frequencies configured for the wireless communication.
Aspect 7: A method for wireless communication at a UE, comprising: transmitting one or more uplink messages in accordance with a first waveform type associated with a first set of parameters, wherein the first set of parameters correspond to a first type of modulation, correspond to a first type of pulse shape, comprise a first set of filtering parameters, or any combination thereof; determining, based at least in part on transmitting the one or more uplink messages, that a condition associated with uplink transmissions at the UE satisfies a threshold; and transmitting, based at least in part on the determination, a request to transition from the first waveform type associated with the first set of parameters to a second waveform type associated with a second set of parameters, wherein the second set of parameters correspond to a second type of modulation, correspond to a second type of pulse shape, comprise a second set of filtering parameters, or any combination thereof.
Aspect 8: The method of aspect 7, wherein determining that the condition associated with uplink transmissions at the UE satisfies the threshold comprises: determining that a power headroom for the UE has crossed the threshold, wherein transmitting the request to transition from the first waveform type to the second waveform type is based at least in part on determining that the power headroom for the UE has crossed the threshold.
Aspect 9: The method of any of aspects 7 through 8, further comprising: receiving, in response to transmitting the request, a grant to transition from the first waveform type to the second waveform type; and transitioning from the first waveform type to the second waveform type based at least in part on receiving the grant.
Aspect 10: The method of any of aspects 7 through 9, further comprising: identifying a configuration for waveform type selection at the UE; and transitioning from the first waveform type to the second waveform type in accordance with the configuration and based at least in part on transmitting the request.
Aspect 11: The method of aspect 10, wherein the configuration indicates whether the UE is allowed to transition between waveform types for one or more types of uplink messages, and transitioning from the first waveform type to the second waveform type is based at least in part on the one or more uplink messages comprising a type of uplink messages included in the one or more types of uplink messages.
Aspect 12: The method of any of aspects 10 through 11, wherein the configuration comprises a threshold for transitioning between waveform types, and the condition comprises the threshold being satisfied by one or more metrics associated with uplink transmissions by the UE.
Aspect 13: The method of any of aspects 10 through 12, wherein the configuration comprises a time duration associated with transitioning between waveform types, the time duration is measured from a time at which the UE transmits the request, and transitioning from the first waveform type to the second waveform type occurs after at least the time duration has elapsed since transmitting the request.
Aspect 14: The method of any of aspects 7 through 13, wherein the condition comprises a non-linearity metric associated with a power amplifier at the UE, a power headroom, a peak to average power ratio, an average transmit power, or any combination thereof.
Aspect 15: A method for wireless communication at a UE, comprising: receiving first signaling indicative of a rule pertaining to waveform type selection for a type of uplink message included in a random access procedure, the rule associated with information within a type of downlink message included in the random access procedure; receiving, during the random access procedure, the information within a downlink message of the type of downlink message; determining a waveform type for an uplink message of the type of uplink message based at least in part on the information included in the downlink message and the rule; and transmitting, during the random access procedure, the uplink message using the determined waveform type.
Aspect 16: The method of aspect 15, wherein determining the waveform type based at least in part on the information included in the downlink message and the rule comprises: interpreting a bitfield of the downlink message in accordance with the rule, the bitfield comprising the information; and determining the waveform type based at least in part on the interpretation of the bitfield.
Aspect 17: The method of any of aspects 15 through 16, further comprising: performing the random access procedure as part of a beam failure recovery procedure or a handover procedure, wherein determining the waveform type is based at least in part on the random access procedure being performed as part of the beam failure recovery procedure or the handover procedure.
Aspect 18: The method of any of aspects 15 through 17, further comprising: transmitting an indication of a request to transition from a first waveform type to a second waveform type for the type of uplink message, wherein receiving the first signaling is based at least in part on transmitting the request.
Aspect 19: The method of aspect 18, wherein transmitting the request to transition from the first waveform type to the second waveform type comprises: transmitting a random access preamble via a random access occasion, wherein the request is indicated by the random access occasion, a sequence associated with the random access preamble, or both; or transmitting a random access preamble over one or more frequency resources, wherein the request is indicated by the one or more frequency resources, a bandwidth part associated with the one or more frequency resources, or both; or transmitting a set of two or more random access preambles, wherein the request is indicated by the set of two or more random access preambles.
Aspect 20: The method of any of aspects 15 through 19, further comprising: transmitting an indication of a UE capability associated with waveform type selection at the UE, wherein receiving the first signaling is based at least in part on the UE capability.
Aspect 21: An apparatus comprising a memory, a transceiver, and at least one processor coupled with the memory and the transceiver, the at least one processor configured to perform a method of any of aspects 1 through 6.
Aspect 22: An apparatus for wireless communication at a UE, comprising at least one means for performing a method of any of aspects 1 through 6.
Aspect 23: A non-transitory computer-readable medium storing code for wireless communication at a UE, the code comprising instructions executable by a processor to perform a method of any of aspects 1 through 6.
Aspect 24: An apparatus comprising a memory, a transceiver, and at least one processor coupled with the memory and the transceiver, the at least one processor configured to perform a method of any of aspects 7 through 14.
Aspect 25: An apparatus for wireless communication at a UE, comprising at least one means for performing a method of any of aspects 7 through 14.
Aspect 26: A non-transitory computer-readable medium storing code for wireless communication at a UE, the code comprising instructions executable by a processor to perform a method of any of aspects 7 through 14.
Aspect 27: An apparatus comprising a memory, a transceiver, and at least one processor coupled with the memory and the transceiver, the at least one processor configured to perform a method of any of aspects 15 through 20.
Aspect 28: An apparatus for wireless communication at a UE, comprising at least one means for performing a method of any of aspects 15 through 20.
Aspect 29: A non-transitory computer-readable medium storing code for wireless communication at a UE, the code comprising instructions executable by a processor to perform a method of any of aspects 15 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving first signaling that schedules a set of uplink messages for the UE;
transmitting a first portion of the set of uplink messages in accordance with a first waveform type associated with a first set of parameters;
receiving second signaling that indicates for the UE to transition from the first waveform type associated with the first set of parameters to a second waveform type associated with a second set of parameters; and
transmitting a second portion of the set of uplink messages in accordance with the second waveform type associated with the second set of parameters.

2. The method of claim 1, wherein the second signaling is received after transmitting at least one uplink message included in the first portion of the set of uplink messages, the method further comprising:
transitioning from the first waveform type to the second waveform type based at least in part on an elapsed time since the second signaling is received at the UE satisfying a threshold, wherein transmitting the second portion of the set of uplink messages in accordance with the second waveform type is based at least in part on the transitioning.

3. The method of claim 1, further comprising:
determining that the first portion of the set of uplink messages is associated with a set of reference signals for performing channel estimation; and
waiting to transition from the first waveform type to the second waveform type until after transmitting the first portion of the set of uplink messages, the waiting based at least in part on the determination that the first portion of the set of uplink messages is associated with the set of reference signals for performing channel estimation.

4. The method of claim 1, further comprising:
receiving third signaling indicating that the UE is allowed to transmit different portions of the set of uplink messages in accordance with different waveform types, wherein transmitting the second portion of the set of uplink messages in accordance with the second waveform type is based at least in part on the third signaling indicating that the UE is allowed to transmit different portions of the set of uplink messages in accordance with different waveform types.

5. The method of claim 1, further comprising:
transmitting an indication of a UE capability associated with waveform type switching at the UE, wherein receiving the second signaling indicating for the UE to transition from the first waveform type to the second waveform type is based at least in part on the UE capability.

6. The method of claim 5, wherein the UE capability is based at least in part on one or more frequencies configured for the wireless communication.

7. A method for wireless communication at a user equipment (UE), comprising:
transmitting one or more uplink messages in accordance with a first waveform type associated with a first set of parameters, wherein the first set of parameters correspond to a first type of modulation, correspond to a first type of pulse shape, comprise a first set of filtering parameters, or any combination thereof;
determining, based at least in part on transmitting the one or more uplink messages, that a condition associated with uplink transmissions at the UE satisfies a threshold; and
transmitting, based at least in part on the determination, a request to transition from the first waveform type associated with the first set of parameters to a second waveform type associated with a second set of parameters, wherein the second set of parameters correspond to a second type of modulation, correspond to a second type of pulse shape, comprise a second set of filtering parameters, or any combination thereof.

8. The method of claim 7, wherein determining that the condition associated with uplink transmissions at the UE satisfies the threshold comprises:
determining that a power headroom for the UE has crossed the threshold, wherein transmitting the request to transition from the first waveform type to the second waveform type is based at least in part on determining that the power headroom for the UE has crossed the threshold.

9. The method of claim 7, further comprising:
receiving, in response to transmitting the request, a grant to transition from the first waveform type to the second waveform type; and
transitioning from the first waveform type to the second waveform type based at least in part on receiving the grant.

10. The method of claim 7, further comprising:
identifying a configuration for waveform type selection at the UE; and
transitioning from the first waveform type to the second waveform type in accordance with the configuration and based at least in part on transmitting the request.

11. The method of claim 10, wherein:
the configuration indicates whether the UE is allowed to transition between waveform types for one or more types of uplink messages, and
transitioning from the first waveform type to the second waveform type is based at least in part on the one or more uplink messages comprising a type of uplink messages included in the one or more types of uplink messages.

12. The method of claim 10, wherein:
the configuration comprises a threshold for transitioning between waveform types, and
the condition comprises the threshold being satisfied by one or more metrics associated with uplink transmissions by the UE.

13. The method of claim 10, wherein:
the configuration comprises a time duration associated with transitioning between waveform types,
the time duration is measured from a time at which the UE transmits the request, and
transitioning from the first waveform type to the second waveform type occurs after at least the time duration has elapsed since transmitting the request.

14. The method of claim 7, wherein the condition comprises a non-linearity metric associated with a power amplifier at the UE, a power headroom, a peak to average power ratio, an average transmit power, or any combination thereof.

15. A method for wireless communication at a user equipment (UE), comprising:
receiving first signaling indicative of a rule pertaining to waveform type selection for a type of uplink message included in a random access procedure, the rule associated with information within a type of downlink message included in the random access procedure;
receiving, during the random access procedure, the information within a downlink message of the type of downlink message;
determining a waveform type for an uplink message of the type of uplink message based at least in part on the information included in the downlink message and the rule; and
transmitting, during the random access procedure, the uplink message using the determined waveform type.

16. The method of claim 15, wherein determining the waveform type based at least in part on the information included in the downlink message and the rule comprises:
interpreting a bitfield of the downlink message in accordance with the rule, the bitfield comprising the information; and
determining the waveform type based at least in part on the interpretation of the bitfield.

17. The method of claim 15, further comprising:
performing the random access procedure as part of a beam failure recovery procedure or a handover procedure, wherein determining the waveform type is based at least in part on the random access procedure being performed as part of the beam failure recovery procedure or the handover procedure.

18. The method of claim 15, further comprising:
transmitting an indication of a request to transition from a first waveform type to a second waveform type for the type of uplink message, wherein receiving the first signaling is based at least in part on transmitting the request.

19. The method of claim 18, wherein transmitting the request to transition from the first waveform type to the second waveform type comprises:
transmitting a random access preamble via a random access occasion, wherein the request is indicated by the random access occasion, a sequence associated with the random access preamble, or both; or
transmitting a random access preamble over one or more frequency resources, wherein the request is indicated by the one or more frequency resources, a bandwidth part associated with the one or more frequency resources, or both; or
transmitting a set of two or more random access preambles, wherein the request is indicated by the set of two or more random access preambles.

20. The method of claim 15, further comprising:
transmitting an indication of a UE capability associated with waveform type selection at the UE, wherein receiving the first signaling is based at least in part on the UE capability.
